(19) United States
(12) Patent Application Publication
(10) Pub. No.: US 2004/0095467 A1
(43) Pub. Date: May 20, 2004

(54) Monitoring system and monitoring method

(76) Inventor: Hirokazu Koizumi, Tokyo (JP)

Correspondence Address: Dickstein Shapiro Morin & Oshinsky, 41st Floor, 1177 Avenue of the Americas, New York, NY, 10036-2714, US

(21) Appl. No.: 10/468,820

(22) PCT Filed: Feb. 26, 2002
(86) PCT No.: PCT/JP02/01754

(30) Foreign Application Priority Data
Feb. 26, 2001 (JP) 2001-051186

(51) Int. Cl. H04N 5/225

(52) U.S. Cl. 348/169; 348/152

(57) ABSTRACT

A monitoring system includes a camera section, a request unit and a state data generating unit. The camera section takes a predetermined area for a target person. The request unit issues a state data request to request a state data showing the state of the target person and shows the state data acquired in response to the state data request to the user. The state data generating unit provides the state data showing the presence/absence state of the target person in the predetermined area based on a first image and a second-image in response to the state data request. The first image is taken by a camera section at a first time and the second image is taken by the camera section at a second time after the first time.

### TECHNICAL FIELD

The present invention relates to a monitoring system and a monitoring method, and more particularly to a monitoring system using a camera and a monitoring method.

### BACKGROUND ART

As networks such as the Internet and intranets and picture coding techniques develop, a camera image has been able to be seen in a remote location. Also, a network camera is being produced, which transmits a live picture to a terminal through a network. For example, a camera AXIS2100 (product type No.: 0106-1) commercially available from Acsiscommunications is a network camera, which can display a camera image on a browser through a network using the picture coding technique standardized in JPEG (Joint Photographic Coding Experts Group). The JPEG standard is set forth in ISO/IEC (International Organization for Standardization/International Electrotechnical Commission) 10918. An application of person presence state confirmation using this network camera is raising in recent years. The following examples of the person presence state confirmation are given such as confirmation of a congestion situation of visitors in a shop, confirmation of the presence/absence state of employees in an office, and labor control. This is important technique in the person presence state confirmation.

FIG. 1 shows a display system which displays a picture on Web (World Wide Web) as a conventional technique of the person presence state confirmation. As shown in FIG. 1, the display system of the picture on Web according to the conventional technique contains a PC terminal 91 on a user side as an image request source, a network camera 92, and a network 2 such as the Internet and intranets. The network 2 connects the PC terminal 91 and the network camera 92 with each other. The user specifies an IP (Internet Protocol) address of the network camera 92 on a browser on the PC terminal 91 to require an image. The network camera 92 takes a picture in response to the specification of the IP address, compresses the taken picture as picture data using JPEG coding technique, and transmits the compressed picture data to the PC terminal 91 through the network 2. The PC terminal 91 receives the compressed picture data and displays it on the browser as a picture requested by the user. By using the conventional display system of the picture on Web, the presence of a person in a remote location can be confirmed.

Also, a “presence state management system, a presence state managing method and a storage medium” is disclosed in Japanese Laid Open Patent Application (JP-P2000-78276A). In this conventional example, the presence state management system is composed of a camera, a communication section, a monitoring section of input data from the camera, a determining section which determines the presence/absence state of a person which is contained in the input data, and a section which switches a telephone response based on the determination result of the presence/absence state. When a telephone is called, the presence/absence state of the called person is automatically determined, and an absence message is replied to a caller. Thus, the caller can know the presence/absence state of the called person easily at a low cost.

Also, a “monitoring system” is disclosed in Japanese Laid Open Patent Application (JP-A-Heisei 8-55288). In this conventional example, the monitoring system is composed of a pattern forming section for forming a pattern in a background, an imaging section for taking an image of the background, a background image storage section which previously stores the background image when any object does not exist in the background, a pattern comparing section which compares a current image inputted from the imaging section and the background image previously stored in the background image storage section, and a determining section which determines whether or not the object exists, from the output from the pattern comparing section. The presence/absence state of the object to the background is detected from the image data. Thus, the presence/absence state of an obstacle and so on can be surely determined even in any environment.

Also, a “communication support system” is disclosed in the Japanese Laid Open Patent Application (JP-A-Heisei 8-249545). In this conventional example, the communication support system is composed of a plurality of communication terminals which can use sound, picture or both of the picture and the sound, and a network which links the plurality of communication terminals. Each of the plurality of communication terminals is composed of a distinguishing section which distinguishes a presence state of a person, a communication section which transmits a presence state data of the person relating to a communication terminal to another communication terminal which requested the presence state data when a change from the absence state to the presence state is detected based on the distinguishing result of the distinguishing section, and a display section which displays the presence state of the person in the form of visual data or auditory data based on the presence state data based on the presence state data sent from the communication terminal by transmitting a transmission request of the presence state data from the other communication terminal. The communication support system provides an opportunity of a communication with the person based on the presence state of the person to be communicated.

Also, an “absence state notice system” is disclosed in Japanese Examined Patent application (JP-B-Heisei 7-105844). In this conventional example, the absence state notice system is composed of an illumination switch monitor which monitors which of a turn-on state and a turn-off state a switch for turning on or off illumination in a room where a terminal is installed is set to, an illumination memory which stores a combination of the illumination switch and a telephone number of the terminal, a distinguishing section which refers to the illumination memory when a call to the terminal arrives to select the illumination switch corresponding to the telephone number of the terminal, and distinguishes whether or not the selected illumination switch is set to the turn-on state, through the illumination switch monitor, and a connection section which connects a call originating terminal and an absence state notice apparatus when it is distinguished by the distinguishing section that the illumination switch is set to the turn-off state. The operation of registration of the absence state or cancellation does not have to carry out from the terminal accommodated in a switching apparatus.

By the way, in the above conventional examples, there is not a notice function of a person presence data indicating the presence of a person. Therefore, when a target person is in an absence state, the user needs to access the image frequently to know the return of the target person and to determine the presence/absence state of the target person from the displayed image.

Also, there is not a notice function of conduct data indicating a conduct of the target person. Therefore, when the target person is present but takes a conduct for which the target person cannot meet another person, e.g., attends a meeting, a mere notice function of the presence/absence state of the target person is not enough to know the conduct of the target person. To know the conduct of the target person, the user needs access an image frequently to determine the conduct of the target person from the displayed image. Therefore, this imposes the time and labor on the user to check the conduct of the target person.

Also, there is a risk that the privacy of the target person is infringed because the image of the target person is directly displayed.

Moreover, the current state of the target person is only displayed, and a statistical process of the states is not carried out. Therefore, it is not possible to use the conventional examples for the management of the shop and the control of the employees.

### DISCLOSURE OF INVENTION

An object of the present invention is to provide a monitoring system and a monitoring method in which an operation of a user to determine a presence/absence state can be eliminated.

Another object of the present invention is to provide a monitoring system and a monitoring method in which an operation of a user to determine a conduct of a person can be eliminated

Another object of the present invention is to provide a monitoring system and a monitoring method in which the risk of the privacy infringement can be prevented.

Another object of the present invention is to provide a monitoring system and a monitoring method which can be used for the management of a shop and the control of employees.

In an aspect of the present invention, a monitoring system includes a camera section, a request unit and a state data generating unit. The camera section takes a predetermined area for the target person. The request unit issues a state data request to request a state data showing a state of the target person, and shows the state data acquired in response to the state data request to the user. The state data generating unit provides the state data showing a presence/absence state of the target person in the predetermined area based on a first image and a second image in response to the state data request. The first image is taken by the camera section at a first time and the second image taken by the camera section at a second time after the first time.

The monitoring system may further include a network, the request unit is provided for a first terminal on a side of the user which is connected with the network. The state data generating unit is provided for a second terminal connected with the first terminal through the network, to receive the state data request through the network and to transmit the state data to the first terminal.

Also, the monitoring system may include a network and a server connected with the network. The request unit is provided for a first terminal on a side of the user which is connected with the network. The state data generating unit is provided for a second terminal connected with the first terminal through the network, to receive the state data request through the network and to store the state data in the server. The first terminal acquires the state data from the server.

Also, the monitoring system may include a network, and the request unit is provided for a first terminal on a side of the user which is connected with the network. The state data generating unit is provided for a second terminal connected with the first terminal through the network, to hold the generated state data, and the first terminal acquires the state data from the second terminal.

Also, the monitoring system may include a network, and the request unit and the state data generating unit are provided for a first terminal on a side of the user which is connected with the network.

Also, the camera section may be connected with the state data generating unit through the network.

Also, the state data generating unit transmits the state data in one of formats of Web site data and E-mail.

Also, the state data generating unit may include a request input section which receives the state data request; a determining section which supplies the state data showing the presence/absence state of the target person in the predetermined area based on the first image and the second image in response to reception of the state data request by the request input section; and a result output section which outputs the state data supplied by the determining section. In this case, the determining section determines the presence/absence state of the target person in the predetermined area based on a brightness difference between corresponding pixels of the first image and the second image in response to reception of the state data request by the request input section, and generates the state data showing the result of the determination.

The result output section may have a result storage section which stores the state data. The result output section compares the state data supplied by the determining section as a current state data and the state data stored in the result storage section as a previous state data, and outputs the current state data when the current state data does not coincide with the previous state data.

Also, the state data generating unit may include a statistical data calculating section which calculates a statistical data showing a statistic value of a result of the determination based on the state data. In this case, the statistic data may be an absence state percentage, or the statistic data is a degree of congestion.

Also, the state data generating unit may generate the state data showing the presence/absence state of the target person in the predetermined area based on the first image and the second image and store in a state data storage section together with a date and time data. The statistic data calculating section may calculate the statistic data based on a time series of the state data and a time series of the date and time data stored in the state data storage section. In this case, the statistic data may be a time change of the degree of congestion. Also, the statistic data may be a time change of a congestion place, or the statistic data may be a time change of a flow of persons.

Also, the state data generating unit may always acquire the second image from the camera section and generates the state data and supplies the latest state data in response to the state data request.

Also, the state data generating unit may acquire the second image from the camera section in response to the state data request, and generates the state data and supplies the state data.

In another aspect of the present invention, a monitoring method is achieved by (a) taking a predetermined area for a target person as an image, wherein a first image is taken at a first time and a second image is taken at a second time after the first time; by (b) issuing a state data request to request a state data showing a state of the target person; by (c) providing the state data showing a presence/absence state of the target person in the predetermined area based on the first image and the second image in response to the state data request; and by (d) showing the state data acquired in response to the state data request won to the user.

Here, the state data may be one of formats of a Web site data and E-mail.

Also, the (c) providing may be achieved by (e) receiving the state data request; by (f) supplying the state data showing the presence/absence state of the target person in the predetermined area based on the first image and the second image in response to the reception of the state data request; and by (g) outputting the supplied state data. In this case, the (f) supplying may be achieved by determining the presence/absence state of the target person in the predetermined area based on a brightness difference between corresponding pixels of the first image and the second image in response to the reception of the state data request; and by generating and supplying the state data based on a result of the determination.

Here, the (g) outputting may be achieved by comparing the state data supplied as current state data and a previous state data; and by outputting the current state data, when the current state data does not coincide with the previous state data.

Also, the monitoring method may further include calculating a statistical data showing a statistics of the results of the determination based on the state data. In this case, the statistic data may be an absence state percentage, or 7 the statistic data may be a degree of congestion.

Also, the (f) supplying may be achieved by generating the state data showing the presence/absence state of the target person in the predetermined area based on the first image and the second image; by holding the state data together with a date and time data, and the calculating may be achieved by calculating the statistic data based on a time series of the state data and a time series of the date and time data stored in a state data storage section. In this case, the statistic data may be a time change of a degree of the congestion, or the statistic data may be a time change of a congestion place. In addition, the statistic data may be a time change of a flow of persons.

Also, the (a) taking is always carried out, and the (c) providing may be achieved by generating the state data from the second image; and by supplying the latest state data in response to the state data request.

Also, the (a) taking is carried out to take the predetermined area for the target person in response to the state data request. The (c) providing may be achieved by getting the second image in response to the state data request; and by generating and supplying the state data based on the first image and the second image.

In another aspect of the present invention, a recording medium in which a program is stored for executing a monitoring method, which has the functions of (a) taking a predetermined area for a target person as an image, wherein a first image is taken at a first time and a second image is taken at a second time after the first time; and (b) providing the state data showing a presence/absence state of the target person in the predetermined area based on the first image and the second image in response to a state data request.

Also, the state data may be one of formats of a Web site data and E-mail.

Also, the (b) providing may includes the functions of (c) receiving the state data request; (d) supplying the state data showing the presence/absence state of the target person in the predetermined area based on the first image and the second image in response to the reception of the state data request; and (e) outputting the supplied state data. In this case, the (d) supplying may include the functions of determining the presence/absence state of the target person in the predetermined area based on a brightness difference between corresponding pixels of the first image and the second image in response to the reception of the state data request; and generating and supplying the state data based on a result of the determination.

Also, the method may include a function of (f) outputting the supplied state data, and the (f) outputting may include the functions of comparing the state data supplied as current state data and a previous state data; and outputting the current state data, when the current state data does not coincide with the previous state data.

Also, the method further may include the calculating a statistical data showing a statistics of the results of the determination based on the state data. In this case, the statistic data may be an absence state percentage, or the statistic data may be a degree of congestion.

Also, the (d) supplying may include the functions of generating the state data showing the presence/absence state of the target person in the predetermined area based on the first image and the second image; and holding the state data together with a date and time data, and the calculating may include the function of calculating the statistic data based on a time series of the state data and a time series of the date and time data stored in a state data storage section. In this case, the statistic data may be a time change of a degree of the congestion, or the statistic data may be a time change of a congestion place. In addition, the statistic data may be a time change of a flow of persons.

Also, the (a) taking is always carried out, and the (b) providing may include the functions of generating the state data from the second image; and supplying the latest state data in response to the state data request.

Also, the (a) taking is carried out to take the predetermined area for the target person in response to the state data request, and the (b) providing may include the functions of getting the second image in response to the state data request; and generating and supplying the state data based on the first image and the second image.

### BRIEF DESCRIPTION OF DRAWINGS

FIG. 1 is a block diagram showing the structure of a conventional image display system;

FIG. 2 is a block diagram showing the structure of a monitoring system according to s first embodiment of the present invention;

FIG. 3 is a block diagram showing the structure of the monitoring system according to a second embodiment of the present invention;

FIG. 4 is a block diagram showing the structure of the monitoring system according to a third embodiment of the present invention;

FIG. 5 is a block diagram showing the structure of the monitoring system according to the fourth embodiment of the present invention;

FIG. 6 is a block diagram showing the structure of the monitoring system according to a fifth embodiment of the present invention;

FIG. 7 is a flow chart showing an operation from the reception of a state data request to the transmission of a presence state data in the monitoring system according to the first embodiment of the present invention;

FIG. 8 is a flow chart showing an operation when a determining process is always carried out, in the monitoring system according to the first embodiment of the present invention;

FIG. 9A is a flow chart showing an operation of a camera connection terminal in the monitoring system according to the second embodiment of the present invention, and FIG. 9B is a flow chart showing an operation of a request source terminal in the monitoring system according to the second embodiment of the present invention;

FIG. 10 is a flow chart showing an operation to acquire a presence state data from a server in response to a state data request in the monitoring system according to the second embodiment of the present invention;

FIG. 11 is a flow chart showing an operation from the input of the state data request to the end of the determining process in the monitoring system according to the third embodiment of the present invention;

FIG. 12 is a flow chart showing an operation when the determining process is always carried out in the monitoring system according to the third embodiment of the present invention;

FIG. 13A is a flow chart showing an operation of a camera connection terminal in the monitoring system according to the fourth embodiment of the present invention, and FIG. 13B is a flow chart showing an operation of a request source terminal in the monitoring system according to the second embodiment of the present invention;

FIG. 14 is a flow chart showing an operation to acquire a presence state data from a server in response to the state data request in the monitoring system according to the fourth embodiment of the present invention;

FIG. 15 is a flow chart showing an operation of the monitoring system according to the fifth embodiment of the present invention;

FIGS. 16A and 16B are diagram showing examples of formats of the state data request and presence state data;

FIGS. 17A and 17B are diagrams showing other examples of formats of the state data request and presence state data; and

FIG. 18A is a diagram showing an example of the format of statistical data and FIG. 18B is a diagram showing another example of the format of the statistical data.

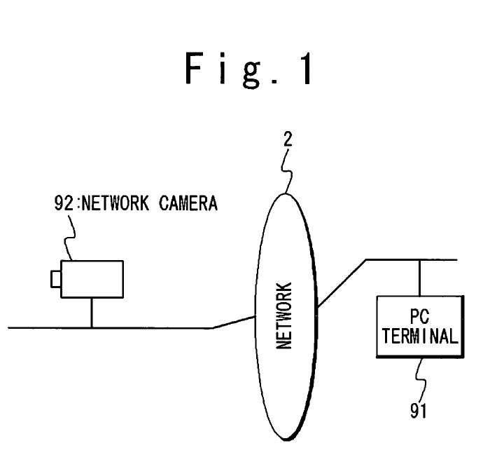

### BEST MODE FOR CARRYING OUT THE INVENTION

Hereinafter, a monitoring system of the present invention will be described with reference to the attached drawings.

(First Embodiment)

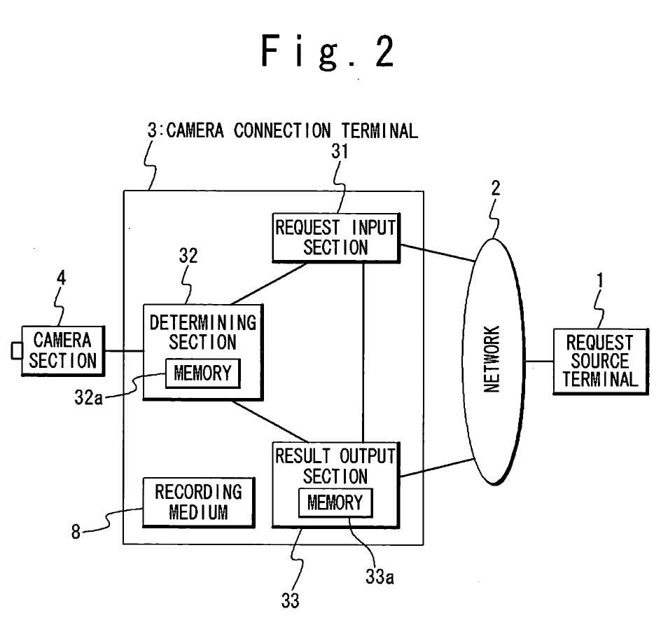

FIG. 2 is a block diagram showing the structure of the monitoring system according to the first embodiment of the present invention. Referring to FIG. 2, the monitoring system according to the first embodiment is composed of a request source terminal 1 as an image request source on the side of a user, a network 2 such as the Internet and intranets, a camera section 4 which takes an image of a predetermined area, and a camera connection terminal 3 connected with the camera section 4 and the network 2. The network 2 connects the request source terminal 1 and the camera connection terminal 3 with each other. Also, the camera connection terminal 3 operates based on a program recorded on a recording medium 8. Also, the camera connection terminal 3 may be connected with a plurality of camera sections 4 and may be connected only with a corresponding camera section 4.

The request source terminal 1 generates a state data request to check the presence/absence state of a target person in the predetermined area and transmits the state data request to the camera connection terminal 3 through the network 2. The camera connection terminal 3 determines the state of the target person in the predetermined area from the image taken by the camera section 4 in response to the reception of the state data request, and transmits a state data showing the result of the determination to the request source terminal 1 through the network 2. The request source terminal 1 provides the state data to the user. In this way, the user can know the state of the target person.

The camera connection terminal 3 is composed of a request input section 31, a determining section 32, and a result output section 33.

The request input section 31 receives the state data request transmitted from the request source terminal 1 and outputs to the determining section 32 and the result output section 33 in response to the reception of the state data request.

The determining section 32 has a memory 32a and stores the image taken by the camera section 4 in the memory 32a. In this way, in the memory 32a are stored an image taken previously by the camera section 4 at a specific time as a reference image and an image of the predetermined area taken by the camera section 4 at a time different from the specific time, e.g., at a current time as a comparison image (a current image). The determining section 32 compares the reference image and the comparison image, determines the presence/absence state of the target person in the predetermined area and generates a determination resultant data indicating the result of the determination. Specifically, the determining section 32 carries out (A) a determination of a state based on the presence/absence state of the target person; (B) a determination of a meeting state of the target person; (C) a determination of a calling state of the target person; and (D) a determination of a refusal state of the target person with another person, and generates the determination resultant data. The determining section 32 sends the generated determination resultant data to the result output section 33.

The result output section 33 has a clock (not shown) and a memory 33a, and stores the determination resultant data transmitted from the determining section 32 in the memory 33a, as a current state data together with a date and time data. Also, the result output section 33 transmits the current state data to the request source terminal 1 through the network 2. The result output section 33 may transmit a current image data to the request source terminal 1 in addition to the state data.

The determining section 32 may carry out a determining process repeatedly with no relation to the state data request. Also, for saving electric power, the determining section 32 may start the determining process when the state data request is received by the request input section 31 and may end it when an end condition is met. The end condition includes a change of the state data, elapse of a predetermined time, and issuing of a stop instruction by the user. For example, in the end condition, the change of the state data is that the state data detected by the determining section 32 changes from an absence state during a meeting into a presence state. The elapse of the predetermined time is elapse of the predetermined time after the state data request is inputted from the user. The issuing of the stop instruction by the user is that the stop instruction is issued by operating by the user a stop icon displayed on a browser of the request source terminal 1, and the request input section 31 receives the stop instruction.

Next, the image processing carried out in the determining section 32 will be described.

First, a method of determining (A) the presence/absence state of the target person will be described. The method of determining (A) the presence/absence state of the target person can be divided into a method (A1) of determining the movement by using a difference between frames and a method (A2) of determining the presence of the target person by using a difference between a background image and a current image.

In the method (A1) of determining the movement by using the difference between the frames, a brightness difference between a pixel of a frame and a corresponding pixel of another frame which is different from the frame in time is calculated over all the pixels. At this time, the image of the frame leading temporally is a reference image and the image of the frame following temporally is handled as a comparison image. Because the brightness difference is generated between the pixels when there the target person moves around, the determining section 32 determines the presence state of the target person when change pixels having the brightness difference are equal to or more than a predetermined number and determines the absence state otherwise. At this time, because the brightness difference is sometimes generated due to noise when the target person moves, the determining section 32 recognizes the pixel having the brightness difference equal to or more than a threshold value as the change pixel. Also, because the change pixel is not detected when the target person stands still, the determining section 32 sometimes erroneously determines to be the absence state of the target person. To cope with this, it is desirable that an image of a frame apart from the reference frame by a predetermined time or more is used as the comparison image because the stationary state of the target person is limited in a time.

In the method (A2) of determining the presence state of the target person by using the difference between the background image and the current image, the background image is taken previously by the camera section 4 when the target person does not exist and is stored in the memory 32a of the determining section 32 as a reference image. The determining section 32 calculates the brightness difference of the background image (the reference image) and the comparison image (the current image). When the target person exists, the brightness difference is generated between pixels in a predetermined area. The determining section 32 determines the presence state of the target person when the brightness difference is generated and determines the absence state of the target person when the brightness difference is not generated. At this time, the brightness difference is sometimes generated due to noise even when the target person does not exist. However, this problem can be solved by using the same method as the above.

A background brightness difference is sometimes generated between an old background image and a current background image because of illumination change. In this case, the determining section 32 calculates an average brightness change value of each of the background image and the current image for a predetermined region, and then calculates a ratio of the brightness difference between the pixels to the average brightness change value. The determining section 32 may determine the presence state when the pixels with the ratio larger than a predetermined value exist for a number equal to or more than a predetermined number.

Next, the method (B) of determining the meeting state of the target person will be described.

In the method (B) of determining the meeting state of the target person, for example, the background where the target person does not exist is taken by the camera section 4 as a background image and the background image is stored in the memory 32a of the determining section 32 previously. The determining section 32 calculates a brightness difference between the stored background image and a current image for every set of corresponding pixels. The change pixels having the brightness differences are generated for the region corresponding to a position where the target person exists, and a lump of change pixels is formed by connecting the change pixels. Such a lump of change pixels is regarded as being one target person. The determining section 32 determines that the target person is on a meeting when a plurality of target persons exist. Because the determining section 32 counts noise as one person when noise exists, the determining section 32 determines as the target person the lump of pixels having the brightness difference equal to or larger than a threshold value. In this way, it is possible to prevent an erroneous determination due to the noise. Also, the threshold value is set to the area of the lump of change pixels connected with one another, and the pixels below the threshold value are determined to be noise. Thus, it is possible to reduce the erroneous determination. Moreover, to cope with the brightness difference between the old background image and the current background image caused based on illumination change, the determining section 32 calculates an average brightness change value of each of the background image and the current image for a predetermined region, and then calculates a ratio of the brightness difference between the pixels to the average brightness change value. At this time, the pixel with the ratio equal to or larger than a predetermined value is determined to be the change pixel, and the lump of the change pixels may be regarded as one person.

Next, the method (C) of determining a calling state of the target person will be described.

In the method (C) of determining the calling state of the target person, a telephone area is taken by the camera section 4 in a state that a telephone that is not used and is stored in the memory 32a as the reference image. Also, the telephone area is taken by the camera section 4 at a current time and is stored in the memory 32a as a current image. The determining section 32 compares the reference image and the current image and determines whether the target person is on the calling when the brightness difference is large. A threshold value is set when noise exists, because the brightness difference is generated even if the telephone is unused. When the brightness difference equal to or larger to a threshold value exists, the determining section 32 determines that the target person is on the calling. Also, the determining section 32 determines a presence state only when the change pixels having the brightness difference equal to or larger than a threshold value exist more than a predetermined number to cope with the temporary generation of noise equal to or larger than the threshold value. Moreover, the background brightness difference is sometimes generated between the old background image and the current background image due to illumination change. In this case, the determining section 32 calculates an average brightness change value of each of the background image and the current image for a predetermined region, and then calculates a ratio of the brightness difference between the pixels to the average brightness change value. The determining section 32 may determine the presence state when the pixels with the ratio equal to or larger than the predetermined value exist more than a predetermined value.

Next, the method (D) of determining a meeting refusal state of the target person with another person will be described.

In the method of determining the meeting refusal state of the target person with another person, a sign showing the refusal of meeting is placed to be taken by the camera when the target person wants to refuse the meeting with the other person. The image of the sign of this meeting refusal is previously taken by the camera section 4 and is stored in the memory 32a of the determining section 32 as the reference image. The determining section 32 searches whether or not the image of the sign exists in the current image and determines to be meeting refusal when the image of the sign exists. In a search algorithm, an area with the same size as the reference image is extracted from the current image and a brightness difference is calculated between the corresponding pixels of an image extracted from the current image and the reference image. The determining section 32 determines that the extracted image is the image of the sign of the meeting refusal when the extracted image is coincident with the reference image. Another area is extracted from the current image when the difference is caused between the extracted image and the reference image and then the above coincidence processing is carried out again. In this way, when the image of the sign of the meeting refusal is not detected even if the whole current image is searched, the determining section 32 determines that the target person is not in the state of the meeting refusal. Only the change pixels equal to or larger than a threshold value are used for the determination process, because the brightness difference is generated if noise exists. Also, the determining section 32 determines the state of the meeting refusal only when the change pixels having the brightness difference equal to or larger than a threshold value exist more than a predetermined number to cope with the temporary generation of noise equal to or larger than the threshold value. Also, the background brightness difference is sometimes generated between the old background image and the current background image due to illumination change. In this case, the determining section 32 calculates an average brightness change value of each of the background image and the current image for a predetermined region, and then calculates a ratio of the brightness difference between the pixels to the average brightness change value. The determining section 32 may determine the meeting refusal state when the pixels with the ratio equal to or larger than the predetermined value exist more than a predetermined value.

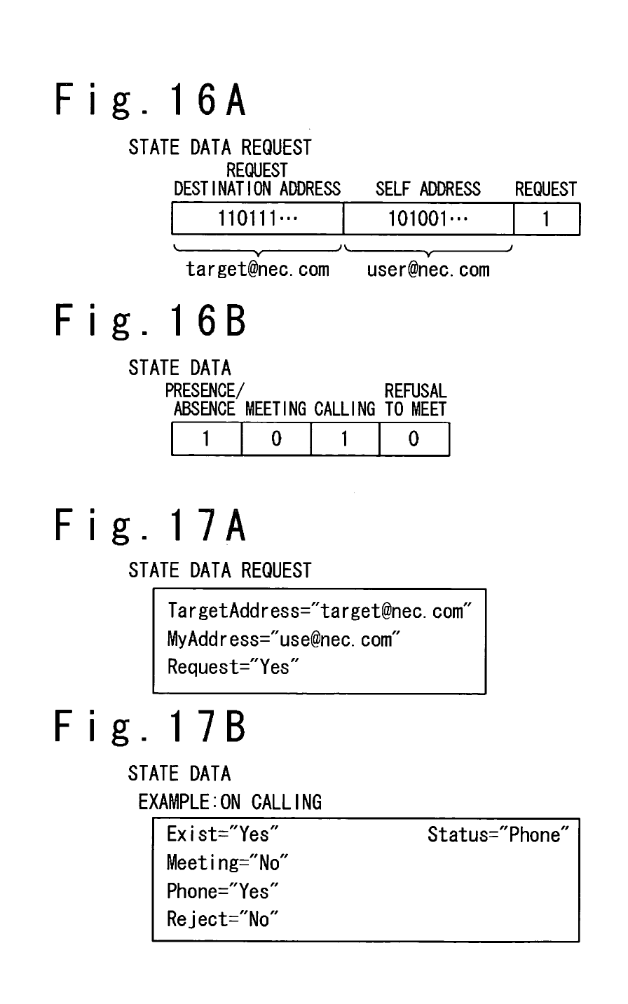

As the formats of the state data request and state data, a bit string format and a text data format are thought of. FIGS. 16A and 16B show examples of the state data request and the state data when the state data request and the state data have the format of a bit string. FIGS. 17A and 17B show examples of the state data request and the state data when the state data request and the state data have the text data format. FIGS. 16A and 16B and FIGS. 17A and 17B show a case that a request destination address is “target@nec.com”, a request source address is “user@nec.com” and the state data is “in the presence state” and “in the telephone”.

Referring to FIGS. 16A and 16B, as for the state data request, the x bits in the head of the bit string show a request destination address “target@nec.com”, and the following y bits of the bit string show the request source address “user@nec.com”. The following bit is set to “1” as shows that the bit string is the state data request. With the state data, each bit shows each state. The bit value showing the presence/absence state is “1”, and the bit value showing a meeting state is “0”. The bit value showing a calling state is “1”, and the bit value showing a meeting refusal state becomes “0”.

In case of the text data shown in FIGS. 17A and 17B, with the state data request, the value of TargetAddress is “target@nec.com” to show a request destination address, and the value of MyAddress is “user@nec.com”. The value of the request is “Yes” to show the request of the state data. Also, with the state data, the value of Presence is “Yes” to show whether it is a presence state or absence, and the value of Meeting is “No” to show a meeting. The value of Phone is “Yes” to show a telephone conversation, and the value of Reject is “No” to show meeting refusal. In addition, the value of Status may be “Phone”.

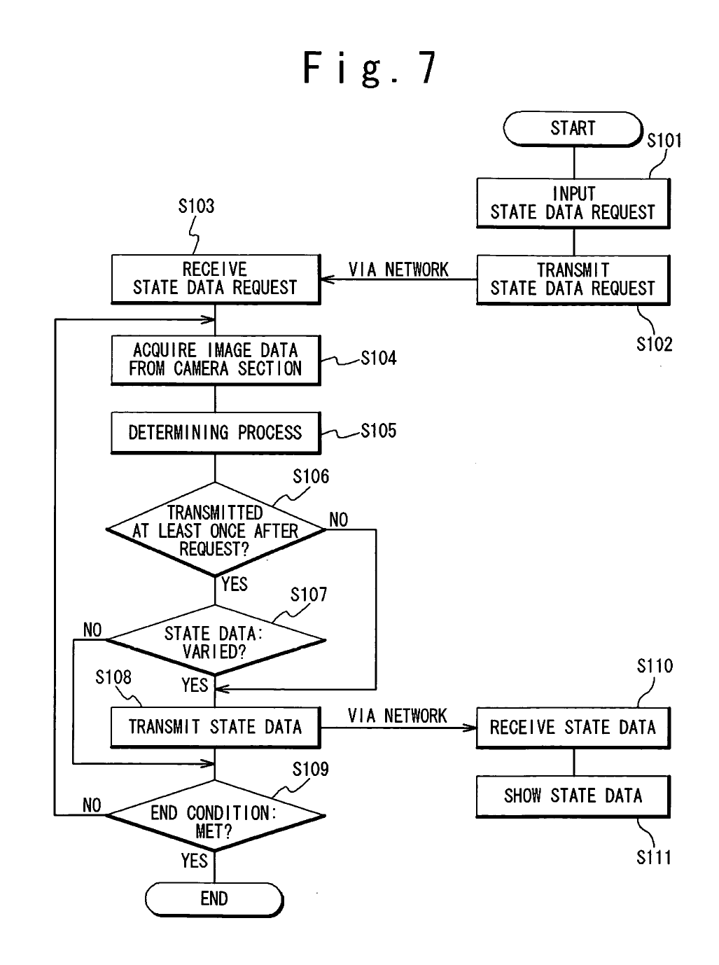

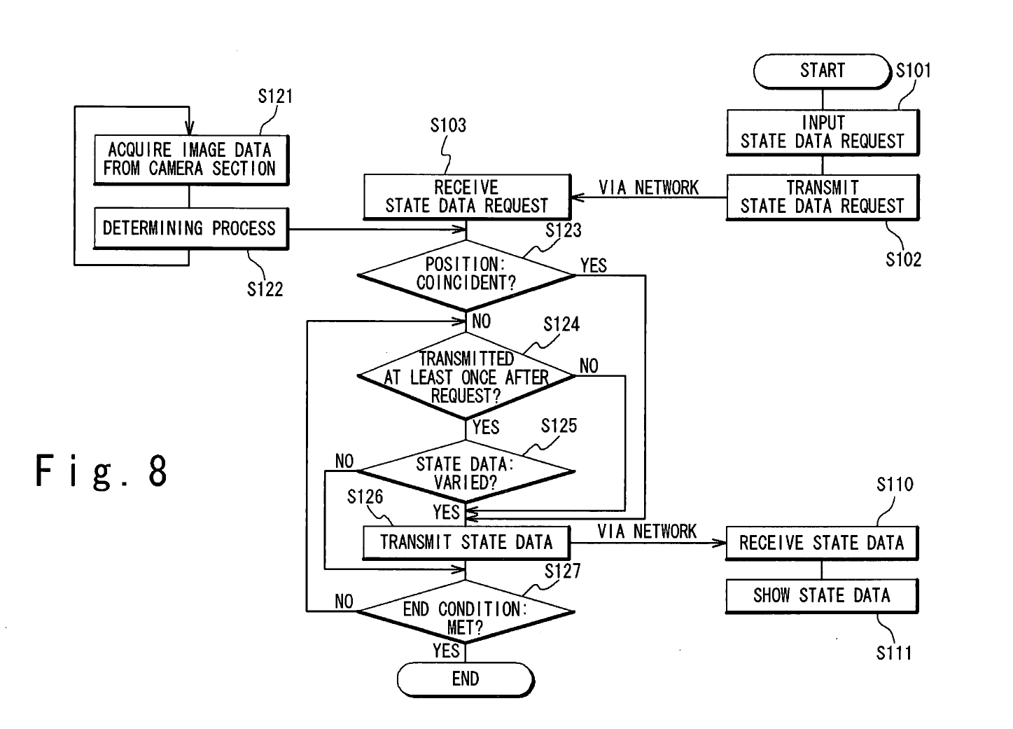

Next, referring to FIG. 7, an operation of the monitoring system according to the above-mentioned first embodiment will be described. In the monitoring system according to the first embodiment, FIG. 7 is a flow chart showing a case (1) where a determining process is carried out in response to the reception of the state data request, and FIG. 8 is a flow chart showing a case where a determining process is always carried out. In this way, the operation of the monitoring system according to the first embodiment is divided into the case (1) where the determining process is carried out in response to the reception of the state data request and the case (2) where the determining process is always carried out. When the determining process is carried out in response to the reception of the state data request, it is not necessary to carry out the determining process wastefully so that the load of the camera connection terminal 3 decreases, resulting in the saving of the electric power. Also, in the following description, a reference image (a background image) is supposed to be already stored in the memory of the determining section.

Referring to FIG. 7, the user inputs the state data request from the request source terminal 1 when the user wants to know the state of the target person in the place where the camera section 4 is installed (Step 101). For example, for the method of inputting the state of the target person, a window for inputting the state data request is displayed on the display of the request source terminal 1. The user selects the name of a target person that the user wants to obtain the state data, from a target person name list (not shown) for the state data request. Each record of the target person name list contains the name of a target person, the addresses of the camera connection terminal 3 and the camera section 4 which are related to the target person, a position data to specify an area to be taken by the camera section 4 for the target person, and an area specifying data to specify an area of the taken image for the target person to detect. In this way, by selecting the target person name, the state data request is transmitted to the camera connection terminal 3 (Step 102). The state data request contains the address of the request source terminal 1, the name of the selected target person, the addresses of the camera connection terminal 3 and the camera section 4 corresponding to the selected target person, the position data, and the area specifying data. Hereinafter, the state data request is same in the present invention, unless being especially described.

The state data request from the request source terminal 1 is received by the request input section 31 of the camera connection terminal 3 specified based on the address through the network 2 (Step 103). The request input section 31 outputs the name, the camera section address, the position data, and the area specifying data of the selected target person contained in the received state data request to the determining section 32, and outputs the address of the request source terminal 1 contained in the received state data request to the result output section 33. The determining section 32 selects the camera section 4 based on the address of the camera section 4 and controls the camera section 4 to direct the target person based on the position data.

Also, the determining section 32 selects a corresponding camera section 4 based on the name of the selected target person contained in the state data request, when the camera section address and the position data are not contained in the state data request. At this time, the determining section 32 has an imaging position list (not shown). The imaging position list contains a name of the target person, and a camera section address to specify a corresponding one of s plurality of camera sections 4, the position data (containing a horizontal angle position, a veridical angle position, and a zoom position of the specified camera section 4, and the area specifying data. The determining section 32 may refer to the camera section address based on the name of the selected target person, and specify the camera section 4 based on the camera section address, and control the position of the camera section 4 specified based on the horizontal angle position, the vertical angle position, and the zoom position.

In this way, the image of the target person is taken by the camera section 4 and the taken image is acquired as a current image by the determining section 32 (Step 104). Next the determining section 32 determines a presence/absence state, a meeting state, a calling state, or a meeting refusal state of the target person from the reference image and the acquired current image for the area specified based on the area specifying data using the image processing (Step 105). In this case, to determine the state through the image processing, either of the above-mentioned methods (A) to (D) is used. Also, the determining section 32 generates the state data based on the determination resultant data. The determining section 32 examines whether the result output section 33 has transmitted the state data to the request source terminal 1 at least once, after the reception of the state data request (Step 106). For this purpose, the determining section 32 acquires the latest date and time of the state data transmitted from the result output section 33 from an area of the memory 33a corresponding to the target person. When it is determined from the acquired latest date and time that the result output section 33 does not yet transmit the state data once (NO at a step 106), the process advances to a step S108. At the step S108, the determining section 32 outputs the state data to the result output section 33. The result output section 33 stores the state data in the memory 33a together with the date and time data. Also, the result output section 33 transmits the state data to the request source terminal 1 using the request source terminal address (Step 108). When it is determined from the acquired latest date and time that the result output section 33 has transmitted the state data once (YES at a step 106), the process advances to a step S107. At the step S107, the result output section 33 compares the determined current state data and the last state data stored in the memory 33a. Thus, it is determined whether the state data changes from the absence state or the meeting state into the presence state, for example. When the state data are not coincident with each other, that is, when the state data changes (YES at a step 107), the result output section 33 stores the determined current state data in the memory 33a together with the current date and time and transmits the current state data to the request source terminal 1 using the request source terminal address (Step 108). After that, the process advances to a step S109. On the other hand, when the state data is determined not to be changed (NO at the step S107), the process advances directly to the step S109 just as it is.

After that, the result output section 33 determines whether an end condition is met (Step 109), and the end condition is the change of the state data stored in the memory 33a, elapse of a predetermined time, or reception of a stop instruction from the user by the request input section 31. When the end condition is not met (NO at the step 109), the result output section 33 outputs non-end indication data to the determining section 32. The determining section 32 repeats the step 104 to acquire image data from the camera section 4. If the end condition is met, the process ends. It should be noted that the end condition may be set by the user before the state data request, or the end condition may be set on manufacturing.

The determination of whether the end condition is met can be realized as follows. As for the change of the state data, the end condition is determined to have been met when the state data stored in the memory 33a at the step 107 is changed. As for the elapse of the predetermined time, a timer (not shown) of the result output section 33 is started in response to the reception of the state data request and the end condition is determined to have been met when the predetermined time lapsed. As for the stop instruction by the user, the end condition is determined to have been met when the stop instruction is transmitted from the request source terminal 1 to the camera connection terminal 3 when the user clicks a stop icon existing in the window on a display of the request source terminal 1 or the window is ended, and then the camera connection terminal 3 receives the stop instruction.

Because a process is ended to avoid an unnecessary operation if the end condition is met, the electric power can be saved. Also, an overload state of the camera connection terminal 3 can be prevented, and the state data continues to be transmitted when the user forgot to issue the stop instruction, so that it can be prevented that the overload state of the network is caused.

Next, the request source terminal 1 receives the state data transmitted through the network 2 (Step 110). The state data is shown on the display of the request source terminal 1. In this way,. the user can know the state of the selected target person (Step 111). There would be various showing methods such as a method of displaying the state data with letters in the window and a method of displaying the state data in the Web browser. When the state data is changed in the monitoring system according to a first embodiment, the state data display is updated.

Next, an operation when the (2) determining process is always carried out will be described with reference to FIG. 8. When the determining process is always carried out, the state data when the state data request is received is transmitted from the camera connection terminal 3 to the request source terminal 1. Thus, it is not necessary to wait for the end of the determining process before the transmission, and it is possible to shorten a response time.

Referring to FIG. 8, the user inputs the state data request from the request source terminal 1 when he wants to know the state of the target person in the place where the camera section 4 is installed (Step 101). The input method is the same as that of the flow chart shown in FIG. 7. Thus, the state data request is transmitted to the camera connection terminal 3 (Step 102).

The determining section 32 of the camera connection terminal 3 specifies one of the camera sections 4 based on the state data request. After that, the determining section 32 acquires the current image taken by the camera section 4 and stores it in the memory 32a, like the steps S104 and S105 shown in FIG. 7 (Step 121). After that, the determining section 32 determines the state of the target person such as the presence/absence state, the meeting state, the calling state, or the meeting refusal from the current image and the reference image (Step 122). In this way, the determining section 32 is always repeating the step 121 and the step 122. Here, the above methods (A) to (D) are used to determine the state data by the image processing. Also, determined state data is stored in the memory 32a of the determining section 32.

Next, the request input section 31 of the camera connection terminal 3 receives the state data request through the network 2 from the request source terminal 1 (Step S103). Like the step S103, the request input section 31 outputs the name of the selected target person and so on contained in the received state data request to the determining section 32, and outputs the address of the request source terminal 1 contained in the received state data request to the result output section 33. The determining section 32 specifies one of the camera sections 4. In the case, if the position of the specified camera section 4 directs to the selected target person (YES at a step S123), the process advances to a step S126. If the position of the specified camera section 4 does not direct to the selected target person (NO at the step S128), the image of the target person is taken by the camera section 4 and the determining section 32 acquires the image as the current image. Next, the determining section 32 determines the state of the target person such as the presence/absence state, the meeting state, the calling state, and the meeting refusal from the acquired current image through the image processing. Here, the above methods (A) to (D) are used for the determination of the state data by the image processing.

As mentioned above, the determining section 32 checks whether or not the result output section 33 has transmitted the state data at least once after the reception of the state data request (Step 124). When the result output section 33 is determined not to have transmitted the state data once (NO at the step 124), the process advances to the step S126. At the step S126, the determining section 32 outputs the state data to the result output section 33. The result output section stores the state data in the memory 33a together with the date and time data. Also, the result output section 33 transmits the state data to the request source terminal 1 (Step 126). When the result output section 33 is determined to have transmitted the state data once (YES at the step 124), the determining section 32 outputs the determined state data to the result output section 33. After that, the process advances to the step S125. The result output section 33 compares the determined current state data and the latest state data stored in the memory 33a. In this way, whether the state data is changed, for example, from the absence state and the meeting state into the presence state is determined. When the coincidence is not obtained as a result of the comparison, that is, when the state data is changed (YES at the step 124), the result output section 33 stores the determined current state data in the memory 33a in addition to the current date and time and transmits the current state data to the request source terminal 1 using the request source address (Step 126). After that, the process advances to the step S127. On the other hand, when the state data is determined not to be changed (NO at a the step S125), the process advances to the step S127 just as it is.

After that, the result output section 33 determines whether the end condition is met (Step 127), and the end condition is the change of the state data stored in the memory 33a, elapse of a predetermined time, and reception of the stop instruction from the user by the request input section 31. When the end condition is not met (NO at the step 109), the result output section 33 outputs non-end indication data to the determining section 32. The determining section 32 repeats the step 104 to acquire image data from the camera section 4. If the end condition is met, the process ends. It should be noted that the end condition may be set by the user before the state data request, or the end condition may be set in manufacturing. The determination of whether the end condition is met is same as mentioned above.

Next, the request source terminal 1 receives the state data transmitted through the network 2 (Step 110). The state data is displayed on the display of the request source terminal 1. In this way, the user can know the state of the selected target person (Step 111). There are methods such as a method of displaying the state data with letters in a window displayed on the display and a method of displaying the state data on a Web browser. The monitoring system according to the first embodiment updates the state data display when the state data is changed.

In the above-mentioned examples, a case where the camera section 4 changes a camera position every target person is considered. However, the step S123 may be omitted when the camera position is fixed and is the exclusive use for the target person.

In the monitoring system according to the first embodiment, when the determining process is always carried out, and the camera position is coincident with the target person, the state data obtained already can be transmitted at the time when the state data request is received. Especially, when the camera sections 4 are provided to have one-to-one correspondence with the target persons, it is not necessary to wait for the transmission until the determining process is ended, and it is possible to shorten a response time.

The monitoring system according to the first embodiment is not limited to the above-mentioned examples. The monitoring system can be applied to the monitoring of the presence/absence state of the target person in the monitoring place but also the monitoring of the ON/OFF state of illumination, the open/close state of the door and so on. This is same in the following embodiments other than the first embodiment.

For example, an average brightness of the pixels in a screen is calculated for the determination of the ON/OFF state of illumination. The OFF state of illumination is determined when the average brightness is below a threshold value and the ON state of illumination is determined when the average brightness is above the threshold value.

As for the open/close state of the door, like the method of determining the calling state, a door image (a reference image) of a door area in the state that the door is closed is previously stored in the memory 32a of the determining section 32, and the determining section 32 calculates the brightness difference between the pixels of the door image in the state that the door is opened and the door image in the state that the door is closed. The door is determined to be opened when the difference exists.

Also, in the monitoring system according to the first embodiment, the state data request is inputted by methods such as a method of pointing an icon displayed on a screen by a pointing device and a method of inputting an address or a target person name to be specified together with a state data acquisition command from a keyboard. This is same in embodiments other than the first embodiment.

Also, the monitoring system according to the first embodiment is not limited to a system in which the camera section 4 and the camera connection terminal 3 are directly connected and the camera section 4, and the camera connection terminal 3 may be connected through the network 2. Also, the monitoring system according to the first embodiment is not limited to the camera connection terminal 3 and may be a server. This is same in embodiments other than the first embodiment.

Through the above description, according to the monitoring system according to the first embodiment of the present invention, an image processing is carried out to the acquired image and the result is notified to the user as the state data. Therefore, when the state of the target person is checked, a time for the user to carry out the determination can be saved.

Also, according to the monitoring system according to the first embodiment of the present invention, the presence/absence state is recognized through the image processing of the acquired image, and the presence/absence state is notified to the user through the network when the presence/absence state is changed. Therefore, the time for the user to carry out the determination of the presence/absence state from the displayed image can be saved.

Also, according to the monitoring system according to the first embodiment of the present invention, the action of the target person can be monitored through the image processing of the obtained image and the action of the target person is notified to the user through the network when the action of the target person is changed. Therefore, time for the user to carry out the determination of the action state of the target person from the displayed image can be saved.

Also, according to the monitoring system according to the first embodiment of the present invention, the acquired image is not shown and only the state data is shown to the user. Therefore, the risk of the privacy infringement to the target person can be prevented.

Moreover, according to the monitoring system according to the first embodiment of the present invention, the state data and a statistical data such as a presence state percentage, an absence state percentage, a degree of congestion, and a congestion place are provided and they can be used for the management of the shop and the employee.

(Second Embodiment)

The monitoring system according to the second embodiment has a server which stores the state data in addition to the structure of the first embodiment. Because the user acquires the state data from the server, the state data can be confirmed by a general Web browser and a Mailer in addition to the operation of the first embodiment and the effect.

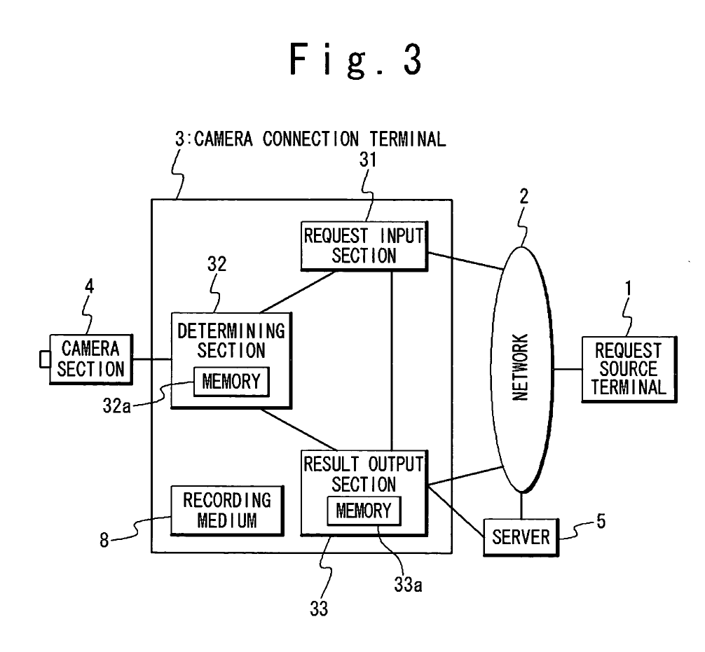

Referring to FIG. 3, the monitoring system according to the second embodiment will be described. FIG. 3 is a block diagram showing the structure of the monitoring system according to the second embodiment of the present invention. It should be noted that in the structure of the monitoring system according to the second embodiment, the same reference numerals are allocated to the same components as those of the first embodiment. Also, an operation of a server added in the monitoring system in the second embodiment will be described. The description of the same operation as in the first embodiment will be omitted.

Referring to FIG. 3, the monitoring system according to the second embodiment is composed of the request source terminal 1 of the user, the network 2 containing an Internet, an intranet and so on, the camera section 4 which takes an image of a predetermined area, the camera connection terminal 3 connected with the camera section 4, and a server 5 containing a Web server, a mail server and so on. The server 5 and the camera connection terminal 3 are connected directly or through the network 2. The network 2 connects the request source terminal 1 and the camera connection terminal 3 with each other. Also, the camera connection terminal 3 can execute the program recorded on the recording medium 8. Also, the camera connection terminal 3 may be connected with a plurality of the camera sections 4 or may be connected only with a corresponding camera section 4.

The request source terminal 1 generates the state data request to check the presence/absence state of the target person in the predetermined area and transmits the state data request to the camera connection terminal 3 through the network 2. At this time, the state data request contains an address of server 5 relating to the target person. The camera connection terminal 3 determines the state of the target person in the predetermined area taken by the camera section 4 in response to the reception of the state data request, and generates the state data showing the result of the determination. The camera connection terminal 3 transmits the state data showing the result of the determination to the server 5 through the network 2 in one of the formats of the Web site data and the E-mail. The request source terminal 1 refers to the server 5 through the network 2, and acquires and shows the state data to the user. In this way, the user can know the state of the target person.

The camera connection terminal 3 is composed of the request input section 31, the determining section 32, and the result output section 33.

The request input section 31 receives the state data request transmitted from the request source terminal 1 and outputs to the determining section 32 and the result output section 33 in response to the reception of the state data request. At the time, the request input section 31 outputs the server address of the target person to the result output section 33. The components and operations are same as those of the first embodiment except the above.

The determining section 32 has the memory 32a, and stores the image taken by the camera section 4 in the memory 32a, like the first embodiment. In this way, in the memory 32a are stored an image taken previously by the camera section 4 at a specific time as the reference image and an image of a predetermined area taken by the camera section 4 at a time different from the specific time, e.g., a current time as a comparison image (a current image). The determining section 32 compares the reference image and the comparison image, determines the presence/absence state of the target person in the predetermined area and generates the determination resultant data showing the result of the determination. The determining section 32 carries out the determining process to determine the presence/absence state from the image data repeatedly. This determining process is carried out irrespective of the state data request. However, for purpose of the power saving, the process may start when the request input section 31 receives the state data request and may end when the end condition, e.g. the end condition described in the first embodiment is met. The image processing method carried out by the determining section 32 is the same as in the first embodiment.

The result output section 33 has a clock (not shown) and the memory 33a and stores the determination resultant data and the date and time data transmitted from the determining section 32 in the memory 33a. Also, the result output section 33 transmits the current state data and the date and time data to the server 5 through the network 2 based on the server address of the target person. The result output section 33 may transmit the current image data in addition to the state data to the server 5. Also, the result output section 33 may carry out the output process to output the current state data and the date and time data when the determined state data changes from the previous state data. The output process may always be carried out. Also, the output process may be started when the state data request is received from the request input section 31 and may be ended when the end condition, e.g., the end condition described in the first embodiment is met.

The storage of the state data in the server 5 may be carried out to update the state data on the server 5 and may accumulate the state data set.

Thus, the monitoring system according to the second embodiment can confirm the state data by a general Web browser and a Mailer in addition to the operation and the effect of the first embodiment.

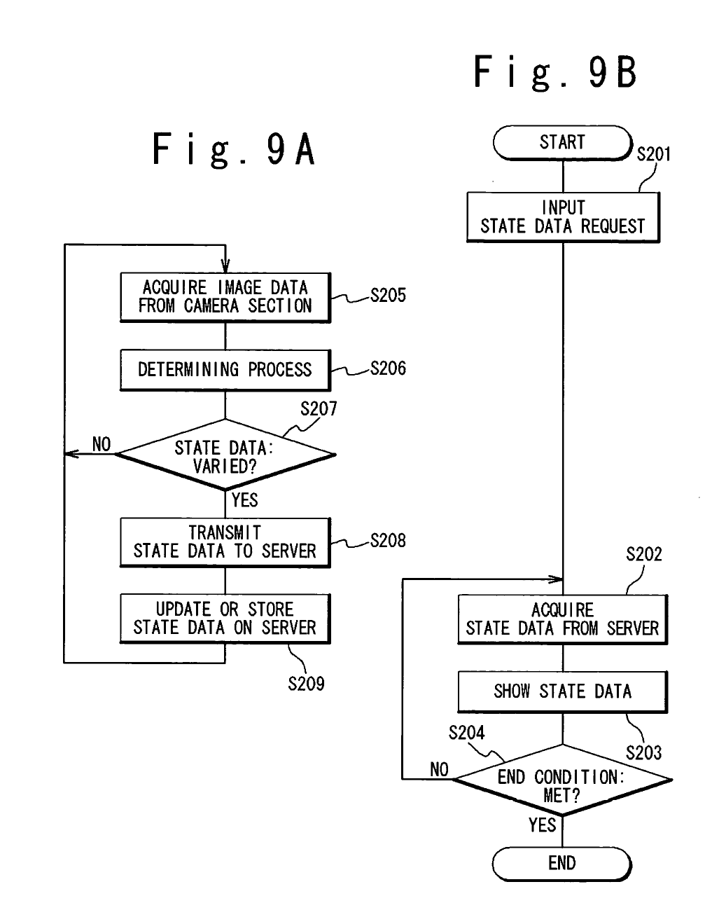

Next, referring to FIGS. 9A and 9B, the operation of the monitoring system according to the above-mentioned second embodiment will be described. FIG. 9A is a flow chart showing the operation of the camera connection terminal when the transmission format in the monitoring system according to the second embodiment of the present invention is Web site data. FIG. 9B is a flow chart showing the operation of the request source terminal when the transmission format in the monitoring system according to the second embodiment of the present invention is Web site data.

First, referring to FIGS. 9A and 9B, the operation when the transmission format is Web site data will be described.

As shown in FIG. 9A, the determining section 32 of the camera connection terminal 3 acquires the image taken by the camera section 4, like the first embodiment (Step 205). The determining section 32 determines the state of the target person such as the presence/absence state, the meeting state, the calling state, the meeting refusal and so on and generates the current state data (Step 206). Here, as the determination of the state data by the image processing is used one of the above-mentioned image processing methods (A) to (D).

The result output section 33 compares the previous state data and the current state data and determines whether or not the current state data varies from the previous state data (Step 207). The result output section 33 transmits the current state data set to the server 5 (Step 208) when coincidence is not obtained as a result of the comparison, i.e., the state data varies (YES at the step 207). Thus, the state data which has been stored in the area allocated to the target person on the server 5 is updated. Or, the state data may be stored in the order temporally (Step 209). The set of the current state data and the date and time data is also stored in the memory 33a. After that, the camera connection terminal 3 repeats the steps 205 to 209.

As shown in FIG. 9B, the user inputs the state data request to the request source terminal 1 when he wants to know the presence state of the target person in the place where the camera section 4 is installed (Step 201). The inputting method is the same as in the first embodiment. The state data request from the request source terminal 1 contains the address of the camera connection terminal 3, the address of the camera section 4, an identification data of the target person and so on, like the first embodiment, in addition to the address of the server 5 and the server address relating to the target person. The request source terminal 1 transmits the state data request to the server 5 through the network 2. In this way, the Web site data corresponding to the state data of the selected target person is acquired from the server 5 (Step 202). The request source terminal 1 shows the presence/absence state on the display by displaying the Web site data acquired from the server 5 on the browser and shows the user about it (Step 203). The showing method is the same as in the first embodiment. After that, the request source terminal 1 determines whether or not the end condition is met, using the end condition and the determining method described in the first embodiment (Step 204). When the end condition is not met (NO at the step 204), the request source terminal 1 repeats the steps 202 to 204.

Next, referring to FIG. 10, the operation when the transmission format is a mail will be described.

Referring to FIG. 10, the user inputs the state data request from the request source terminal 1 when he wants to know the presence state of the target person in the place in which the camera section 4 is installed (Step 201). The inputting method is same as in the first embodiment. The state data request from the request source terminal 1 contains the address of the camera connection terminal 3, the address of the camera section 4, the identification data of the target person and so on, like the first embodiment, in addition to the address of the server and a mail address of the server relating to the target person. The request source terminal 1 transmits the state data request to the camera connection terminal 3 and the server 5 through the network 2 (Step 211). The state data request is received by the camera connection terminal 3 having the address specified through the network 2 from the request source terminal 1 (Step 212).

Next, the request input section 31 of the camera connection terminal 3 receives the state data request and the determining section 32 of the camera connection terminal 3 acquires the image taken by the camera section 4, like the first embodiment (Step 205). The determining section 32 determines the state of the target person such as the presence/absence state, the meeting state, the calling state, and the meeting refusal, and the determining section 32 generates the current state data (Step 206). Here, as the determination of the state data by the image processing is used one of the above-mentioned image processing methods (A) to (D).

The result output section 33 compares the previous state data and the current state data and determines whether or not the current state data varies from the previous state data (Step 207). The result output section 33 transmits the current state data set to the mail address of the server 5 corresponding to the target person when coincidence is not obtained as the result of comparison, i.e., the state data is changed (YES at a the step 207) (Step 208). Thus, the state data which has been stored on the server 5 is updated. Or, the state data may be stored in the order temporally (Step 209). The current state data set is also stored in the memory 33a. After that, the camera connection terminal 3 determines whether or not the end condition is met, using the end condition and the determining method in the first embodiment (Step 213). When the end condition is met (NO at the step 213), the camera connection terminal 3 repeats the steps 205 to 209.

The reason why the output operation is ended based on the end condition is that many E-mails are prevented in case of the output transmission format of an E-mail when the determination of the presence/absence state is repeated by the target person going in and out the imaged place, or when the state of the target person changes from the absence state to the presence state, to the meeting state, to the presence state, to the calling state one after another.

Also, the request source terminal 1 acquires the Web site data for the state data to be written in from the server 5 having the address corresponding to the selected target person through the network 2 (Step 202). The request source terminal 1 shows the current state data on the display by displaying the Web site data acquired from the server 5 on the browser and shows it to the user (Step 203). The showing method is the same as in the first embodiment.

In this way, the monitoring system according to the second embodiment stores the state data in the server, and the user acquires the state data from the server. Therefore, the terminal and application for the exclusive use are unnecessary. The state data can be confirmed by the general Web browser and Mailer.

The monitoring system according to the second embodiment is not limited to above-mentioned description. The monitoring system according to the second embodiment is possible to use for the state determination of the monitor place in addition to the presence state of the target person in the monitor place. For example, the state determination of the monitor place can be applied to the ON/OFF state of illumination, the open/close state of a door and so on.

(Third Embodiment)

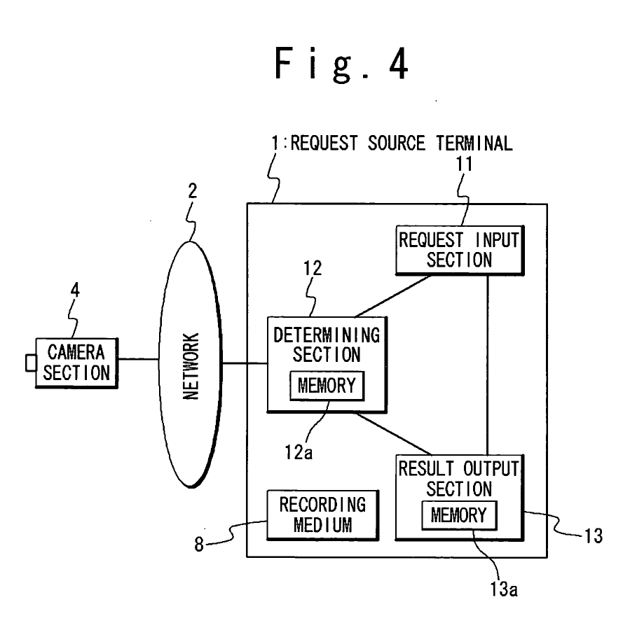

In the monitoring system according to the third embodiment, an effect is achieved that a load of the determining process can be distributed into the respective terminals such that the determining processes are carried out in the terminals of the users, when a plurality of state data requests are generated at a same time, in addition to the effect of the first embodiment. FIG. 4 is a block diagram showing the structure of the monitoring system according to the third embodiment of the present invention. Referring to FIG. 4, the monitoring system according to the third embodiment will be described.

As shown in FIG. 4, the monitoring system according to the third embodiment is composed of a request source terminal 1 of the user as the request source, the network 2 containing an Internet, an intranet and so on, and the camera section 4 which takes the predetermined area as an image. The network 2 connects the request source terminal 1 and the camera section 4 with each other. Also, the request source terminal 1 can execute the program recorded to a recording medium 8.

In order to check the presence/absence state of the target person in the predetermined area, the request source terminal 1 determines the state of the target person from the image of the predetermined area taken by the camera section 4 in response to input of the state data request, generates the state data showing the result of the determination and shows it to the user. In this way, the user can know the state of the target person. In this way, the user only demands the state data from the request source terminal 1 when he wants to know the presence state of the target person in the monitor place by the camera section 4, and the presence/absence state can be shown by the request source terminal 1.

The request source terminal 1 is composed of a request input section 11, a determining section 12, and a result output section 13.

The request input section 11 receives the state data request from the user, and outputs it to the determining section 32 and the result output section 33, like the first embodiment.

The determining section 12 is composed of a memory 12a. The determining section 32 outputs a drive instruction to the camera section 4 through the network 2 in response to the state data request from the request input section 11. The drive instruction contains the address of the camera section 4, the identification data and the position data of the target person, the address of the determining section 12. The camera section 4 specified by the drive instruction takes the current image of the target person based on the identification data and the position data and the taken current image is sent to the determining section 12 using the address of the determining section 12. The determining section 12 stores the received current image in the area of the memory 12a corresponding to the target person, like the first embodiment. In this way, in the memory 12a are stored the image previously taken by the camera section 4 at a specific time as the reference image and the current image taken by the camera section 4 at a time different from the specific time, e.g., at a current time as the comparison image (the current image). The determining section 12 compares the reference image and the comparison image with respect to the area specified by the area specifying data, determines the presence/absence state of the target person in the predetermined area and generates the state data. The determining section 12 carries out the determining process repeatedly to determine the state from the acquired current image and the reference image. The image processing method carried out by the determining section 12 is the same as in the first embodiment. For the purpose of power saving, the determining process may start in response to the input of the state data request to the request input section 11 and may end when an end condition is met, e.g., the end condition described in the first embodiment is met.

The result output section 13 is composed of a clock (not shown) and the memory 33a and stores the state data transmitted from the determining section 12 as the current state data together with the date and time data in the area of the memory 13a corresponding to the target person. After that, the result output section 13 shows the current state data to the user. The result output section 13 may store the current image data in the memory 13a in addition to the state data and the date and time data. Also, the result output section 13 may carry out the output process to outputs the current state data set when the determined current state data changed from the previous state data. The output process may be always carried out and may be started when the state data request is received by the request input section 31 and may be ended when the end condition, e.g., described in the first embodiment is met.

In this way, the monitoring system according to the third embodiment can achieve the effect that the load of the determining process is distributed to the respective terminals when the plurality of state data requests are generated at the same time, in addition to the effect of the first embodiment.

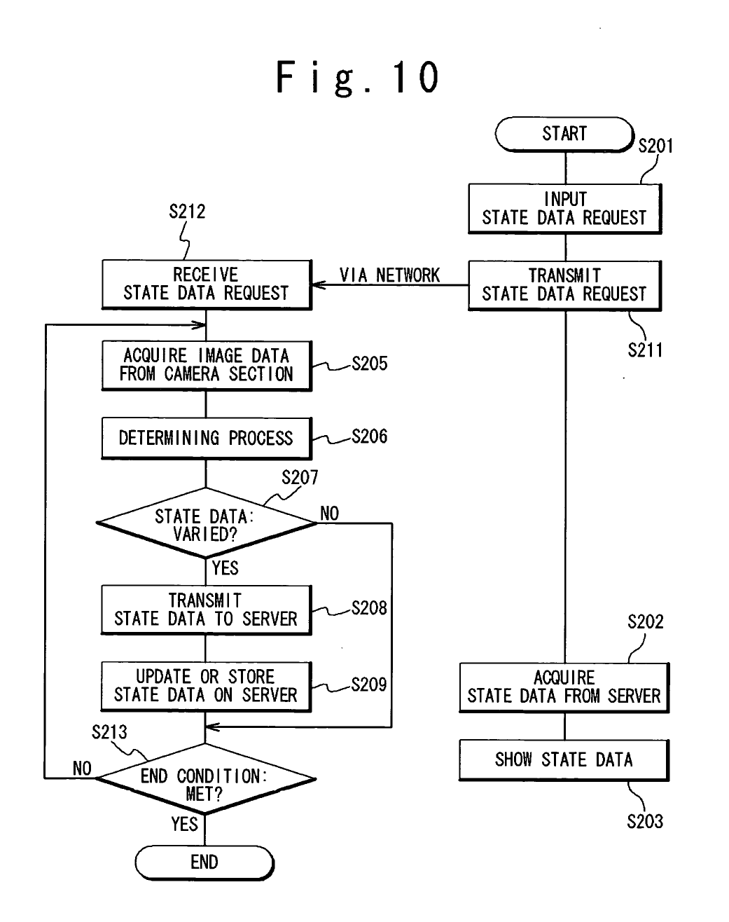

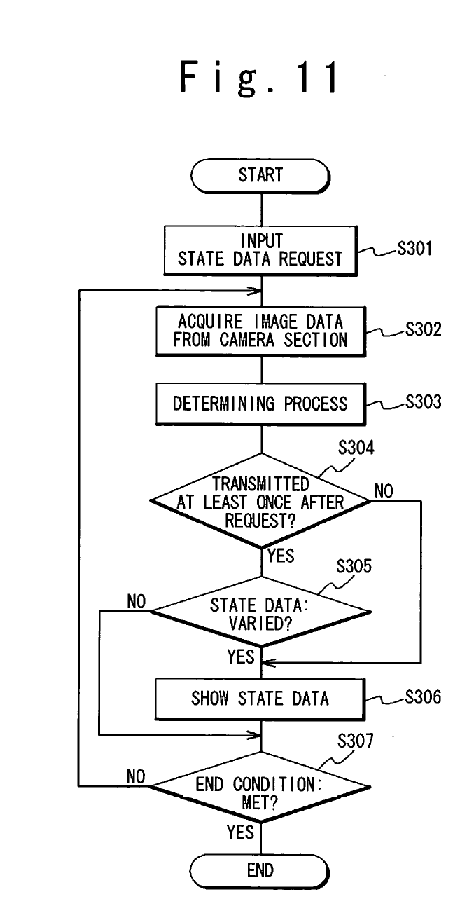

Next, referring to FIG. 11, the operation of the monitoring system according to the above-mentioned third embodiment will be described. FIG. 11 is a flow chart showing an operation when the determining process is carried out in response to input of the state data request in the monitoring system according to the third embodiment of the present invention. Referring to FIG. 11, the operation which the determining process is carried out after the state data request is inputted will be described.

As shown in FIG. 11, the user inputs the state data request from the request source terminal 1 when he wants to know the presence state of the target person in the place where the camera section 4 is installed (Step 301). The inputting method is same as in the first embodiment. The request input section 11 outputs the state data request to the determining section 12 and the result output section 13.

The determining section 12 outputs a drive instruction to the camera section 4 in response to the state data request. In response to the drive instruction, the camera section 4 takes a specified target person as an image and transmits the taken current image to the determining section 12 through the network 2. In this way, the current image is acquired by the determining section 12 (Step 302).

Next, the determining section 12 determines the state of the target person such as the presence/absence state, the meeting state, the calling state, and the meeting refusal from the current image and the reference image with respect to the area specified by the area specifying data by using the image processing, and generates the state data (Step 303). Here, one of the above-mentioned image processing methods (A) to (D) is used for the image processing.

The determining section 12 checks whether or not the result output section 13 has outputted the state data at least once after input of the state data request (Step 304). When the state data is determined not to be outputted (NO at the step 304), the process advances to the step S306. The determining section 12 outputs the current state data to the result output section 13. The result output section 13 stores the current state data in the memory 13a and also shows it to the user (Step 306). The showing method is the same as in the first embodiment. When the state data is determined to be already outputted (YES at the step 304), the process advances to the step S305. At the step S305, the result output section 13 determines whether or not the current state data changed from the previous state data. For this purpose, the result output section 13 compares the current state data and the previous state data stored in the memory 13a (Step 305). The result output section 13 shows the current state data to the user (Step 306) when coincidence is not obtained as a result of the comparison, i.e., the state data changed (YES at the step 305). The showing method is the same as in the first embodiment.

After that, the result output section 13 determines whether or not the end condition is met, using the end condition and the determining process described in the first embodiment (Step 307). When the end condition is not met (NO at the step 307), the result output section 13 repeats the steps 302 to 307.

Next, referring to FIG. 12, the case where the determining process is always carried out will be described.

As shown in FIG. 12, the user inputs the state data request from the request source terminal 1 when he wants to know the presence state of the target person in the place where the camera section 4 is installed (Step 301). The inputting method is same as in the first embodiment. The request input section 11 outputs the state data request to the determining section 12 and the result output section 13.

The determining section 12 outputs a drive instruction to the camera section 4 in response to the state data request. In response to the drive instruction, the camera section 4 determines whether or not the camera section is directed to the target person specified by the drive instruction. If the camera section does not direct to the target person, the camera section 4 is changed in a position to direct to the target person specified by the drive instruction, takes the specified target person as an image, and transmits the image to the determining section 12 through the network 2. In this way, the determining section 12 acquires the current image (Step 311). The determining section 12 determines the state data of the target person such as the presence/absence state, the meeting state, the calling state, and the meeting refusal (Step 312). After that, the determining section 12 repeats the step 311 and the step 312. Here, one of the above-mentioned image processing methods (A) to (D) is used for the determination of the state data by the image processing. Also, the current state data is stored in the memory 12a of the determining section 12.

Next, the determining section 12 checks whether or not the result output section 13 has outputted the state data at least once after input of the state data request, like the first embodiment (Step 304). When the state data is determined not to have been outputted (NO at the step 304), the process advances to the step S306. The determining section 12 outputs the current state data to the result output section 13. The result output section 13 stores the current state data in the memory 13a together with the date and time data, and also shows it to the user (Step 306). The showing method is the same as in the first embodiment. When the state data is determined to have been already outputted (YES at the step 304), the process advances to the step S305. At the step S305, the result output section 13 determines whether or not the current state data changed from the previous state data. For this purpose, the result output section 13 compares the current state data and the previous state data stored in the memory 13a (Step 305). The result output section 13 shows the current state data to the user when coincidence is not obtained as the result of the comparison, i.e., the state data changed (YES at the step 305) (Step 306). The showing method is the same as in the first embodiment.

After that, the result output section 13 determines whether or not the end condition is met, using the end condition and the determining method described in the first embodiment (Step 307). When the end condition is not met (NO at the step 307), the result output section 13 repeats the steps 302 to 307.

Thus, the monitoring system according to the third embodiment is possible to distribute the load of the determining process to the respective terminals when the plurality of state data requests are generated at the same time because the respective terminals of the users carry out the current state determining processes.

The monitoring system according to the third embodiment is not limited to the above-mentioned description. It is possible to use for the state determination of the monitor place in addition to the presence state of the target person in the monitor place. For example, the state determination of the monitor place can be applied to the ON/OFF state of illumination, the open/close state of a door and so on.

(Fourth Embodiment)

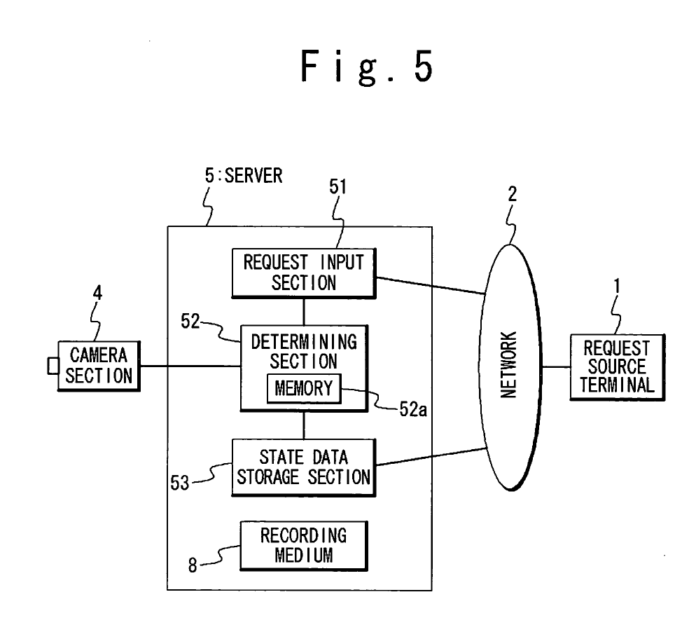

The monitoring system according to the fourth embodiment has the structure that the camera connection terminal is incorporated into the server having the structure of the second embodiment. The user can acquire the state data from the server 5 and confirm the state data by using the general Web browser and Mailer. FIG. 5 is a block diagram showing the structure of the monitoring system according to the fourth embodiment of the present invention. The monitoring system according to the fourth embodiment will be described with reference to FIG. 5. It should be noted that in the structure of the monitoring system according to the fourth embodiment, the same reference numerals as those in the first embodiment are allocated to the same components.

As shown in FIG. 5, the monitoring system according to the fourth embodiment contains the request source terminal 1 as a request source, the network 2 containing an Internet, an intranet and so on, the camera section 4 which takes a predetermined area as the image, and the server 5 connected with the camera section 4. The network 2 connects the request source terminal 1 and the server 5 mutually. Also, the server 5 can execute the program recorded on the recording medium 8.

The request source terminal 1 generates the state data request to check the presence/absence state of the target person in the predetermined area and transmits the state data request to the server 5 through the network 2. The state request data contains the same data as in the first embodiment, in addition to the address of the server 5. In response to reception of the state data request, the server 5 determines the state of the target person in the predetermined area taken by the camera section 4 and generates the state data showing the result of the determination. The server 5 stores the state data showing the result of the determination in the form of the Web site data or the E-mail. The request source terminal 1 refers to the server 5 through the network 2, and acquires and shows the state data to the user. In this way, the user can know the state of the target person.

In response to the reception of the state data request, the server 5 determines the presence/absence state of the target person in the predetermined area and so on based on the reference image taken at the specific time and the current image taken at the current time. Then, the server 5 transmits the state data showing the result of the determination to the request source terminal 1 through the network 2 in one of the forms of the Web site data and the E-mail.

The server 5 is composed of a request input section 51, a determining section 52, and a state data storage section 53. The request input section 51 receives the state data request transmitted from the request source terminal 1 and outputs the state data request to the determining section 52.

The determining section 52 has a memory 52a and stores the current image taken by the camera section 4 in an area of the memory 52a corresponding to the target person. In this way, the reference image and the current image are stored in the memory 52a. The determining section 52 compares the reference image and the comparison image with respect to the area specified by the area specifying data, determines the presence/absence state of the target person in the predetermined area and generates the determination resultant data showing the result of the determination. The image processing method carried out by the determining section 52 is the same as in the first embodiment. The determining section 52 carries out the determining process to determine the presence/absence state from the image data repeatedly. The determining process is carried out irrespective of the state data request. For the purpose of power saving, however, the determining process may be started when the request input section 51 receives the state data request and may be ended when the end condition, e.g., the end condition described in the first embodiment is met.

The state data storage section 53 has a clock (not shown) and stores the state data generated by the determining section 52 together with the date and time data. The state data storage section 53 outputs the stored state data to the request source terminal 1 through the network 2. In this case, the state data may be stored only when the current state data and the previous state data stored in the state data storage section 53 are different or may be always stored. Also, as the storing method, the previous state data stored in the state data storage section 53 may be updated to hold only the latest state data or and the current state data may be newly stored additionally. Also, the state data storage section 53 may output the current state data when the current state data changed from the previous state data. This output process may be always carried out and may be started when the state data request is received by the request input section 51 and may be ended when the end condition described in the first embodiment is met.

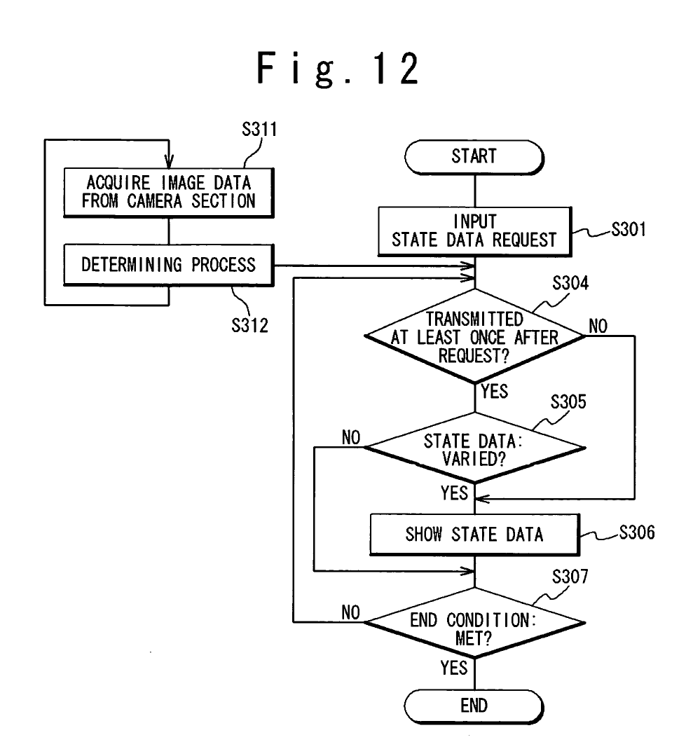

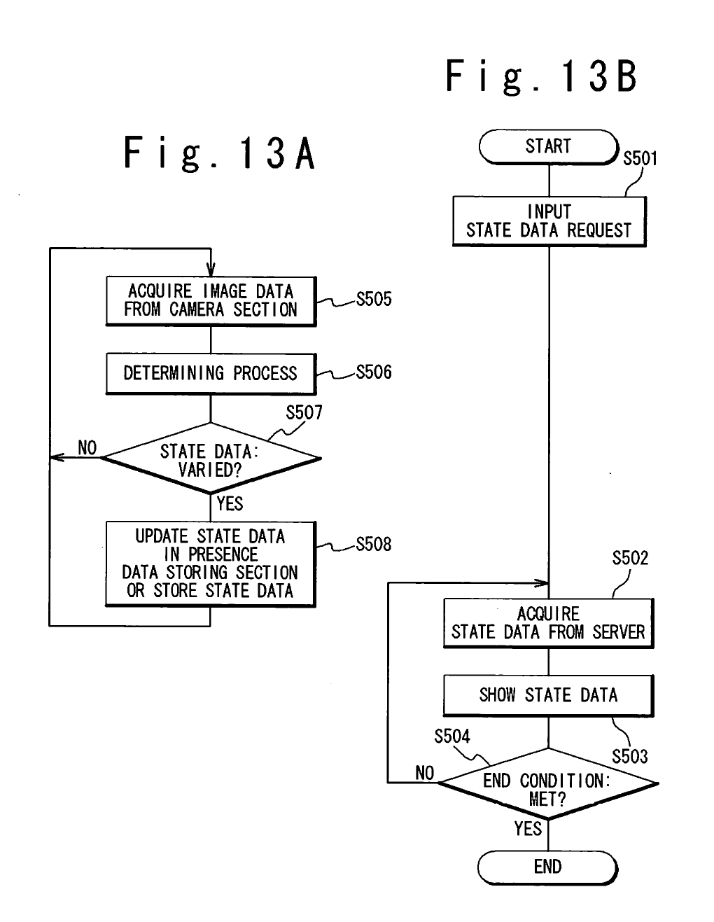

Next, referring to FIGS. 13A and 13B, the operation of the monitoring system according to the fourth embodiment will be described. FIGS. 13A and 13B are flow charts showing the operation of the server 5 when the output transmission format is Web site data in the monitoring system according to the fourth embodiment of the present invention. Referring to FIGS. 13A and 13B, the operation when the output transmission format is Web site data will be described.

As shown in FIG. 13B, the determining section 52 of the server 5 acquires the current image taken by the camera section 4 and stores it in the area of the memory 52a corresponding to the target person (Step 505). After that, the determining section 52 determines the state of the target person such as the presence/absence state, the meeting state, the calling state, and the meeting refusal from the current image and the reference image to the area specified by the area specifying data (Step 506). As the determining method of the state data by the image processing, one of the methods (A) to (D) described in the first embodiment is used.

The state data storage section 53 compares the current state data and the previous state data to determine whether the current state data changed from the previous state data (Step 507). The state data storage section 53 updates the current state data or stores it (Step 508) when coincidence is not obtained as a result of the comparison, i.e., the state data changed (YES at a the step 507). After that, the server 5 repeats the steps 505 to 508.

As shown in FIG. 13A, the user inputs the state data request from the request source terminal 1 when he wants to know the presence state of the target person in the place where the camera section 4 is installed (Step 501). The inputting method is the same as in the first embodiment. The request source terminal 1 transmits the state data request to the server 5. In this case, the address of the server 5 and the server address relating to the target person are contained in the state data request, in addition to the data of the first embodiment. The request source terminal 1 acquires the Web site data for the state data to be written in from the address of the server 5 corresponding to the target person through the network 2 (Step 502). The request source terminal 1 shows the current state on the display by displaying the Web site data obtained from the server 5 on the browser and shows the user about it (Step 503). The showing method is the same as in the first embodiment. After that, the request source terminal 1 determines whether or not the end condition is met, using the end condition and the determining method described in the first embodiment (Step 504). When the end condition is not met (NO at the step 504), the request source terminal 1 repeats the steps 502 to 504.

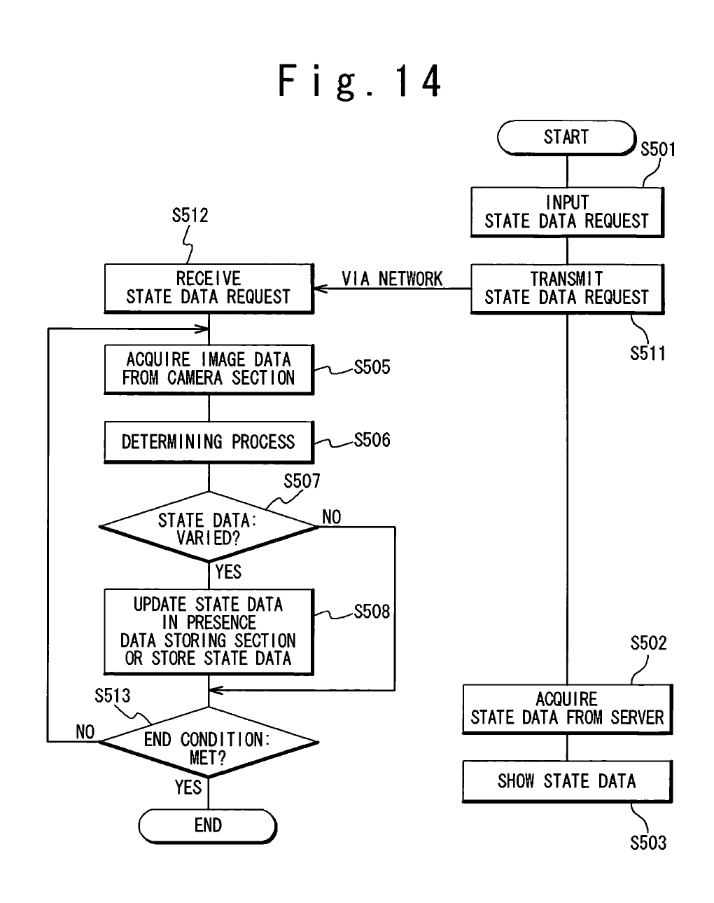

Next, referring to FIG. 14, the operation when the output transmission format is a mail will be described.

As shown in FIG. 14, the user inputs the state data request from the request source terminal 1 when he wants to know the presence state of the target person in the place in which the camera section 4 is installed (Step 501). The inputting method is the same as in the first embodiment. The request source terminal 1 transmits the state data request to the server 5 through the network 2 based on the server address (Step 511). In this case, the state data request transmitted to the server 5 contains an address of the request source terminal address, the address of the server 5, the name of the selected target person and the server of the target person, and the camera section address, position data, area the area specifying data.

Next, the request input section 51 of the server 5 receives the state data request through the network 2 from the request source terminal 1, outputs the name of the selected target person and so on to the determining section 52, like the first embodiment, and outputs the server address of the target person to the state data storage section 53 (Step S512). Like the first embodiment, the determining section 52 acquires the current image taken by the camera section 4 corresponding to the inputted name and stores it in the area of the memory 52a corresponding to the target person (Step 505). Next, the determining section 52 determines the state of the presence/absence state, the meeting state, the calling state, the meeting refusal and so on of the target person by using the image processing from the current image and the reference image to the area specified by the area specifying data (Step 506). As the determining method of the state data by using the image processing, one of the methods (A) to (D) is used.

The state data storage section 53 has a clock (not shown) and compares the current state data and the previous state data to determine whether the current state data changed from the previous state data (Step 507). The process advances to the step S513 when coincidence is obtained as a result of the comparison, i.e., the state data did not change. The state data storage section 53 updates the current state data together with the date and time data and stores it (Step 508) when the coincidence is not obtained as a result of the comparison, i.e., the state data changed (YES at a the step 507)). After that, the server 5 determines whether or not the end condition is met, using the end condition and the determining method described in the first embodiment (Step 513). When the end condition is not met (NO at the step 513), the server 5 repeats the steps 505 to 208.

In case of the output transmission format is an E-mail, the reason why the output operation is ended based on the end condition is that reception of many E-mails can be prevented when the change of the state data of the target person is repeated between the presence state and the absence state in the predetermined area or when that the target person is busy and the state data changed from the absence state to the presence state, to the meeting state, to the presence state, and to the calling state one after another.

Also, the request source terminal 1 acquires the Web site data for the state data to be written in from the address of the server 5 corresponding to the selected target person through the network 2 (Step 502). The request source terminal 1 shows the presence state on the display by displaying the Web site data obtained from the server 5 on the browser and shows the user about it (Step 503). The showing method is the same as in the first embodiment.

Thus, in the monitoring system according to the fourth embodiment, the state data is stored in the server and the user acquires the state data from the server. Therefore, the terminal and the application of the exclusive use are unnecessary, and the state data can be confirmed by using the general Web browser and Mailer.

The monitoring system according to the fourth embodiment is not limited to the above-mentioned example. The monitoring system according to the fourth embodiment is possible to use for the state determination of the monitor place in addition to the presence state of the target person in the monitor place. For example, the state determining method of the monitor place can be applied to the ON/OFF state of illumination, the open/close state of the door and so on.

Through the above description, it could be understood that the monitoring system according to the fourth embodiment can confirm the state data by using the general Web browser and Mailer in addition to the operation of the first embodiment.

(Fifth Embodiment)

In the monitoring system according to the fifth embodiment, by adding a state data storage section and a statistical data calculating section to the structure of the first embodiment and carrying outing statistical calculation from the state data, the useful data such as a congestion percentage can be obtained in addition to the operation of the first embodiment and the effect.

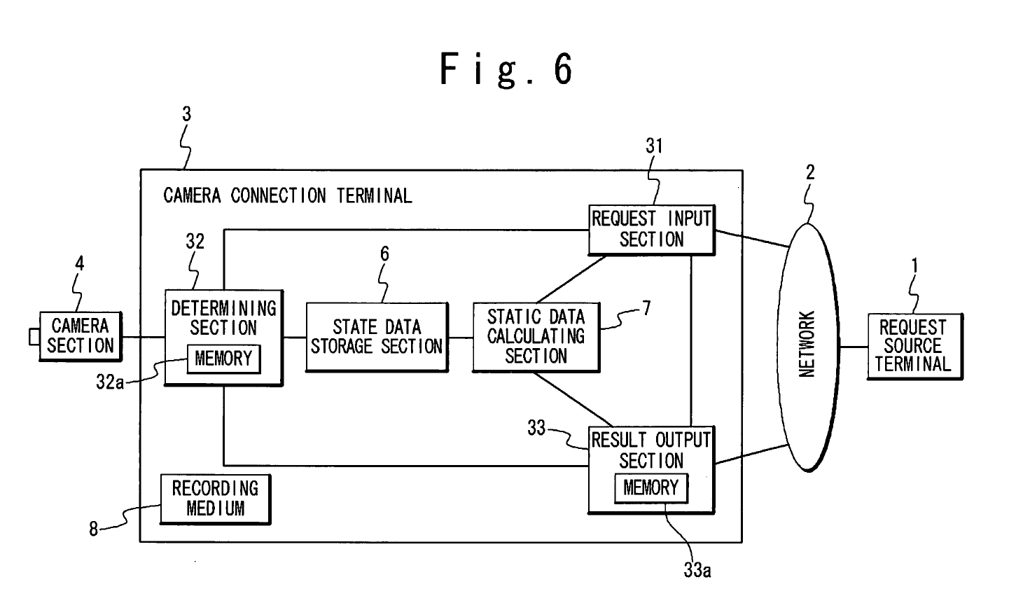

Referring to FIG. 6, the monitoring system according to the fifth embodiment will be described. It should be noted that in the structure of the monitoring system according to the fifth embodiment, the same reference numerals as those in the first embodiment are allocated to the same components. Also, in the monitoring system according to the fifth embodiment, the operation of a state data storage section and a statistical data calculating section which are added will be described. The description of the operation relating to the first embodiment will be omitted.

FIG. 5 is a block diagram showing the structure of the monitoring system according to the fifth embodiment of the present invention. Referring to FIG. 5, the monitoring system according to the fifth embodiment is composed of the request source terminal 1 of the user as the request source, the network 2 containing an Internet, an intranet and so on, the camera connection terminal 3 connected with the camera section 4 which the takes the predetermined area as an image, and the camera section 4. The network 2 connects the request source terminal 1 and the camera connection terminal 3 mutually. Also, the camera connection terminal 3 can execute the program recorded to the recording medium 8.

The request source terminal 1 generates the state data request to check the presence/absence state of the target person in the predetermined area and transmits the state data request to the camera connection terminal 3 through the network 2. Also, the user inputs a statistical data request from the request source terminal 1 to request a statistical data. The statistical data request is transmitted to the camera connection terminal 3 through the network 2 from the request source terminal 1. The request input section 31 of the camera connection terminal 3 receives the statistical data request and outputs the statistical data request to the statistical data calculating section 7.

In response to the reception of the state data request, the camera connection terminal 3 determines the state of the target person in the predetermined area taken by the camera section 4 and generates the current state data showing the result of the determination. The camera connection terminal 3 transmits the current state data to the request source terminal 1 through the network 2 in response to the state data request. The request source terminal 1 shows the current state data to the user. In this way, the user can know the state of the target person. Also, the camera connection terminal 3 transmits the statistical data to the request source terminal 1 through the network 2 in response to the reception of the statistical data request. The request source terminal 1 shows the statistical data to the user. In this way, the user can know statistics in the state of the target person.

The camera connection terminal 3 is composed of the request input section 31, the determining section 32, the result output section 33, the state data storage section 6, and the statistical data calculating section 7.

The request input section 31 receives and outputs the state data request transmitted from the request source terminal 1 to the determining section 32 and the result output section 33, like the first embodiment. Also, the request input section 31 receives and outputs the statistical data request transmitted from the request source terminal 1 to the statistical data calculating section 7 and the result output section 33.

The determining section 32 has the memory 32a and stores the current image taken by the camera section 4 in the memory 32a. In this way, the reference image and the current image are stored in the memory 32a. The determining section 32 compares the reference image and the comparison image with respect to the area specified by the area specifying data, determines the presence/absence state of the target person in the specific area and generates the determination resultant data showing the result of the determination. The image processing method carried out by the determining section 32 is the same as in the first embodiment. More specifically, the determining section 32 carries out the determination (A) of the state based on the presence/absence state of the target person, the determination (B) of the meeting state of the target person, the determination (C) of the calling state of the target person, and the determination (D) of the meeting refusal state of the target person, and generates the determination resultant data. The determining section 32 sends the generated determination resultant data to the result output section 33.

The state data storage section 6 has a clock (not shown) and stores the state data generated by the determining section 32 together with the date and time data.

The statistical data calculating section 7 calculates the statistical data from a time-series state data, i.e., the time series of the state data stored in the state data storage section 6. The calculated statistical data is outputted to the result output section 33.

The result output section 33 has a clock (not shown) and the memory 33a. The result output section 33 compares the current state data from the determining section 32 and the previous state data stored in the memory 33a. The result output section 33 stores the state data from the determining section 32 in the area of the memory 33a corresponding to the target person as the current state data based on the comparison result. Also, the result output section 33 transmits the current state data and the statistical data to the request source terminal 1 through the network 2. At this time, the result output section 33 carries out the output process to output the current state data when the current state data changed from the previous state data. The result output section 33 may transmit the image data to the request source terminal 1 in addition to the current state data.

According to the monitoring system in the fifth embodiment, the management of the employee and the management of congestion in the shop can be carried out by recording a situation of the presence/absence state of the target person(s) in the place taken by the camera section 4 and using data of a presence state percentage and absence state percentage. In case of the management of the employee, it is possible to save a work space by grasping the presence state situation of the employee and sharing desks between the different employees in the presence state time zone. Also, in the office in which a desk work carries out for all the daytime, the working situation can be correctly grasped. In the management of congestion in the shop, for example, a congestion percentage is measured for every time zone of a day through the image processing, and the time changes of the congestion percentage and the congestion place are statistically calculated. Thus, on which counter the visitors center, in which time zone the congestion of visitors occurs or how is a flow of visitors in the shop and so on can be grasped. Thus, the statistical data is useful for the determination of arrangement of the counters and the securing of the space, and it is possible to ease congestion and to improve an earning rate.

The above-mentioned statistical data is an occupation percentage such as the presence state percentage and the absence state percentage, a degree of the congestion and a congestion place, a flow of visitors in the shop and so on. As mentioned above, the state data required for calculation of the statistical data is the state data of the presence/absence state, a ratio of an area of the target persons to a predetermined area, a position and time of the target person(s). The determining section 32 generates the state data corresponding to at least one of the presence/absence state of the target person, an area for the target person(s) and a ratio of the area to a predetermined area, a position of the target person based on the reference image taken at a specific time and the current image taken at a time other than the specific time. The statistical data calculating section 7 calculates the statistical data corresponding to at least one of the presence state percentage/absence state percentage of the target person, a degree of the congestion due to the target person(s), and a place of the congestion due to the target person(s) based on the state data corresponding to at least one of the presence/absence state of the target person, an area for the target person(s) and a ratio of the area to a predetermined area, a position of the target person. The camera connection terminal 3 can determine (S) the occupation percentage such as the presence state percentage and the absence state percentage, (T) the degree of congestion in the shop, (U) the place of congestion in the shop, and (V) the flow of visitors in the shop, from the statistical data and the state data required for calculation of the above mentioned statistical data.

First, the method of calculating the occupation percentage such as the presence state percentage/absence state percentage will be described. In the method of calculating the occupation percentage such as the presence state percentage and the absence state percentage, the presence/absence state is determined by using the method (A2) described in the first embodiment. The state data of the presence/absence state is outputted to the state data storage section 6.

The statistical data calculating section 7 calculates as the statistical data, a percentage of a time of the presence state to a predetermined time of the time series of the state data stored in the state data storage section 6, i.e., the time series state data. The calculated statistical data shows the occupation percentage such as the presence state percentage/absence state percentage.

Next, the method of calculating the degree of congestion in the shop will be described. There are two methods as the method of calculating the degree of the congestion in the shop.

In the first method of calculating the degree of congestion in the shop, the presence or absence of the target person is determined by using the method (A2) described in the first embodiment. The determining section 32 determines the presence or absence of the target person from the brightness difference between the background image (reference image) and the current image with respect to the area specified by the area specifying data. The determining section 32 can calculate a ratio of the pixels for the target person to all the pixels in the current image through the determining process. The determining section 32 outputs the ratio to the state data storage section 6 as the state data. The statistical data calculating section 7 handles the stored ratio as the degree of congestion in the specific area (the statistical data). Also, the statistical data calculating section 7 calculates as the statistical data, a congestion time during which the degree of congestion of the time series of the state data stored in the state data storage section 6, i.e., the time series state data is higher than a predetermined threshold value. That is, the statistical data calculating section 7 calculates which time zone of which day of a week is crowed by summing the state data in units of weeks and calculating an average about each time zone and every day of the week. Thus, the statistical data calculating section 7 can calculate the statistical data of degree of congestion.

In the second method of calculating the degree of congestion, the degree of congestion is calculated by using the method (A2) described in the first embodiment. The determining section 32 allocates a label to each of groups of pixels of the background image and determines the number of visitors from the image of the visitors, supposing that the target persons exist when the pixels with the same label are separated in the current image. Then, the determining section 32 outputs it to the state data storage section 6 as the state data. The statistical data calculating section 7 calculates from the time series state data and a predetermined threshold value as the statistical data, a ratio of a congestion time during which the degree of congestion is higher than the predetermined threshold value to a predetermined time, and here the time series state data is the time series of the numbers of target persons as the state data stored in the state data storage section 6. The calculated statistic data shows the degree of congestion in the shop. That is, the statistical data calculating section 7 calculates which time zone of which day of a week is crowed by summing the state data in units of weeks and calculating an average for each time zone and every day of the week. Thus, the statistical data calculating section 7 can calculate the statistical data of degree of congestion.

Next, the method of determining the place of congestion in the shop will be described.

In the method of determining the congestion place in the shop, the method (A2) described in the first embodiment is first used. The background image is previously stored in the memory 32a of the determining section 32. The determining section 32 divides each of the current image and the background images into a plurality of image blocks, calculates the brightness difference between the corresponding image blocks of the current image and the background image, and calculates a ratio of the image blocks with the brightness difference equal to or larger than a predetermined threshold value to the whole image blocks. The determining section 32 outputs the ratio to the state data storage section 6 as the state data. The statistical data calculating section 7 calculates a total of time series of the state data, i.e., a total of the time series state data equal to or larger than a predetermined threshold value as the statistical data in the congestion time in the congestion place based on the ratio stored of the state data storage section 6. That is, the statistical data calculating section 7 can calculate the statistical data in the congestion place by calculating an average of the state data each time every day of the week and setting the blocks in which the ratios are equal to or larger than the threshold value as the congestion place.

Next, a method of calculating a flow of visitors in the shop will be described.

In the method of calculating the flow of visitors in the shop, the method (A2) described in the first embodiment is used. The background image of a specified shop area (the image of the background taken by the camera section 4) where the visitor does not exist is previously stored in the memory 32a of the determining section 32. The determining section 32 calculates the brightness difference between the background image and the current image in units of corresponding pixels. Because the brightness difference is calculated when the visitor exists, the area where the difference is found is set as a visitor presence area. When the brightness difference is not found, the area is set a visitor absence area. Thus, the presence/absence state of the target person (corresponding to the above mentioned presence or absence state) is determined. The determining section 32 allocates a label to the group of pixels with the brightness differences to extracts the visitor presence area, and regards an average position of all the pixels of the visitor presence area for one person as a presence position of the visitor. The determining section 32 outputs the presence position of the visitor to the state data storage section 6 as the state data. The state data storage section 6 stores the state data from the determining section 32.

The statistical data calculating section 7 arranges the state data stored in the state data storage section 6 in the time series (as the time series state data) and calculates a total of times during which the visitor exists in the time series state data as the statistical data. The calculated statistical data shows a flow of visitors in the shop. That is, the statistical data calculating section 7 can determines the flow of visitors in the shop by tracking the visitor using the time series state data indicating the presence position of the visitor. In the method of tracking the target person, for example, the difference between a presence position (xt1, yt1) at a time t1 of the visitor and a presence position (xt2, yt2) at a time t2 is supposed as a movement of the visitor, and the presence position (xt, yt) of the visitor at a time t is estimated as a position (2xt1-xt2, 2yt1-yt2) by adding a movement to the position at the time t1. One of the visitors who is the nearest to the estimated position at the time t is regarded as the target person. Thus, the target person is tracked.

As described above, the monitoring system according to the fifth embodiment can get the useful data such as the congestion percentage by carrying out the statistical calculation.

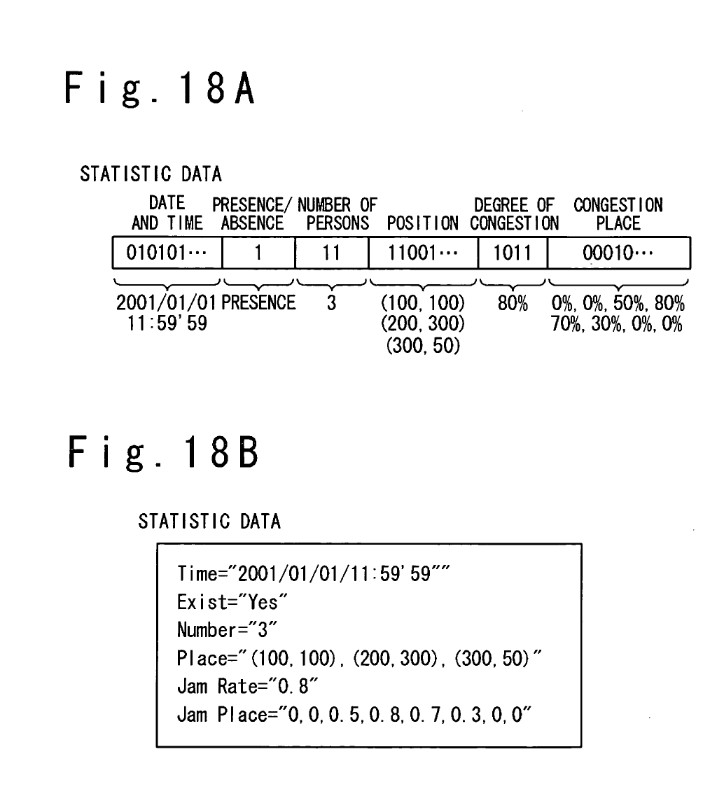

The format of the statistical data is realized as a bit string or a text data. An example of the bit string and an example of the text data are shown by FIGS. 18A and 18B.

FIGS. 18A and 18B show the statistical data in case of the time of “11:59:59, January 1st, 2001”, the state data of the presence state, the target persons of “three”, the positions of “(100, 100), (200, 300), (300, 50)”, the degree of congestion of “80%”, the congestion place of “0%, 0%, 50%, 80%, 70%, 30%, 0%, 0%”.

In case of the bit string, the statistic data request is similar to the state data request. As shown in the FIG. 17(a), the statistical data is composed of a bit data indicating a time, a bit data indicating a presence state or absence state, a bit data indicating the number of persons, a bit data indicating a presence position of the target person, a bit data indicating a degree of congestion, and a bit data indicating a congestion place.

In case of the text data, a statistic data request is same as the state data request. As shown in the FIG. 17(b), the statistical data is composed of a Time value indicating a time is “2001/01/01”, an Exist value indicating that the state data is “Yes”, a Number-of-person value indicating that the number of people is “3”, a Place value indicating that the presence position of the target person is “(100, 100), (200, 300), (300, 50)”, a Jam Rate value indicating that a degree of the congestion is “0.8”, and a Jam Place value indicating that a congestion place is “0, 0, 0.5, 0.8, 0.7, 0.3, 0.0”.

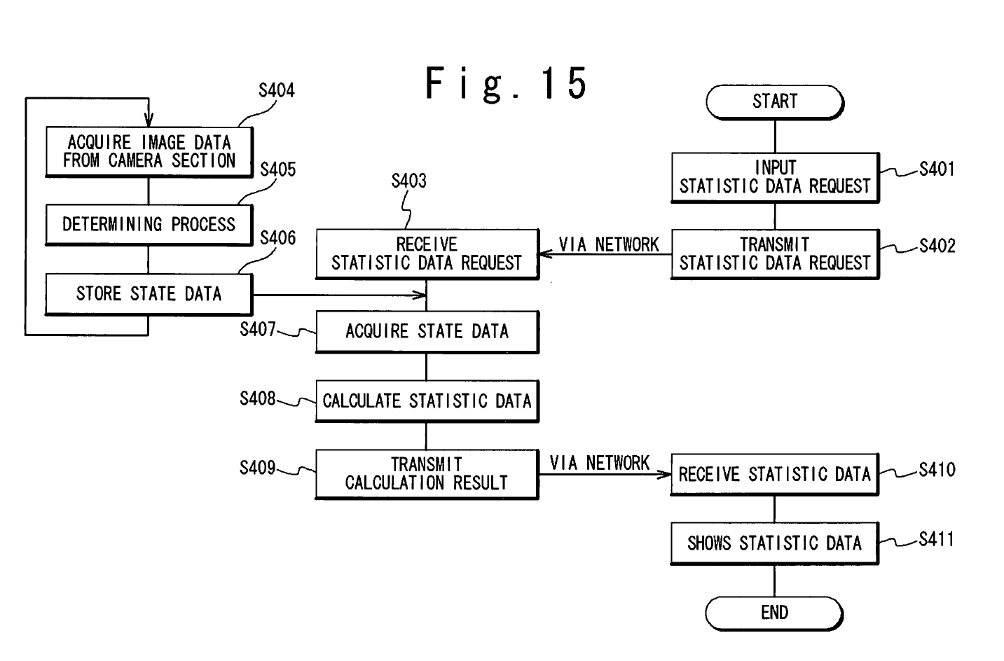

Next, referring to FIG. 15, the operation of the monitoring system according to an above-mentioned fifth embodiment will be described. As shown in FIG. 15, the determining section 32 of the camera connection terminal 3 acquires the image data showing the image taken by the camera section 4 (a step 404), and determines a state of the presence/absence state of the target person, the position of the target person, the number of the target persons and so on (Step 405). Here, for the image processing, one of the methods (A) to (D) described in the first embodiment and the methods (S) to (V) is used. The state data storage section 6 of the camera connection terminal 3 stores the current state data together with the time and date data (Step 406). The camera connection terminal 3 repeats the step 404 and the step 406.

The user inputs a state data request from the request source terminal 1 when he wants to know a statistical data of the presence state and the absence state in the place where the camera section 4 is installed (Step 401). For example, as the method of inputting, a window for the state data request input is displayed on the display of the request source terminal 1. The user selects a name of the target person (the target person or the shop) to want to know the state data as the state data request. At this time, the user can specify the address of the camera connection terminal 3 corresponding to the selected target person, by selecting the statistical data from the state data and the statistical data in case of the target person. Also, the user can specify the address of the camera connection terminal 3 corresponding to the selected shop, by selecting the kind of the statistical data in case of the shop. Also, the request source terminal 1 transmits the state data request to the address corresponding to the selected target person (the target person or the shop) (Step 402). The state data request contains the name of the selected target person, the address of the camera connection terminal 3 and the address of the request source terminal 1. The state data request from the request source terminal 1 is received by the camera connection terminal 3 having the specified address through the network 2 (Step 403).

Next, the request input section 31 of the camera connection terminal 3 receives the state data request from the request source terminal 1 through the network 2, and outputs the name of the selected target person contained in the received state data request to the determining section 32 and the address of the request source terminal 1 contained in the received state data request possesses to the result output section 33. The determining section 32 inputs the name of the selected target person contained in the state data request from the request input section 31, and acquires the state data (for example, the state data for past one month) which are already obtained by the camera section 4 corresponding to the inputted name from the state data storage section 6 (Step 407).

Next, the statistical data calculating section 7 calculates the statistical data from the state data acquired from the state data storage section 6 (step 408) and outputs to the result output section 33. Here, one of the methods (S) to (V) is used for the calculation of the statistic data. The result output section 33 transmits the statistical data calculated by the statistical data calculating section 7 to the request source terminal 1 (Step 409).

Next, the request source terminal 1 receives the statistical data transmitted through the network 2 (step 410), and displays the presence state and the absence state and so on on the display based on the statistical data to show it to the user (Step 411). The showing method is the same as in the first embodiment and a graph may be displayed in addition to the letters.

In this way, the monitoring system according to the fifth embodiment can obtain the useful data such as the congestion percentage from the state data by carrying out the statistical calculation..

The monitoring system according to the fifth embodiment is not limited to the above-mentioned description. The present invention is possible to apply for the state determination of the monitor place in addition to the presence state of the target person in the monitor place. For example, the state determination of the monitor place can be applied to the states such as ON/OFF state of illumination, the open/close state of a door.

Also, the monitoring system according to the fifth embodiment is not limited to a case that the camera section 4 and the camera connection terminal 3 are directly connected, and the camera section 4 and the camera connection terminal 3 may be connected through the network 2.

Also, the present invention is not limited to a case that the state data storage section 6 and statistical data calculating section 7 are added only to the monitoring system according to the fifth embodiment, and they may be added to the first to fourth embodiments. In this case, the state data storage section 6 and the statistical data calculating section 7 are provided for the camera connection terminal 3 of the monitoring system in the first and second embodiments, for the request source terminal 1 in the monitoring system according to the third embodiment, and for the server 5 in the monitoring system according to the fourth embodiment.

Also, the monitoring system according to the fifth embodiment is not limited to the camera connection terminal 3 and may be a server.

Through the above description, the monitoring system according to the fifth embodiment can obtained the useful data such as the congestion percentage from the state data by carrying out the statistical calculation in addition to the effect of the first embodiment.

Also, the monitoring system of the present invention can save a work for determination by user himself when the investigation of the target person is carried out.

1. A monitoring system may include:
a camera section which takes a predetermined area for the target person;
a request unit which issues a state data request to request a state data showing a state of said target person, and shows said state data acquired in response to the state data request to the user;
a state data generating unit which provides said state data showing a presence/absence state of said target person in said predetermined area based on a first image and a second image in response to said state data request, and
wherein said first image is taken by said camera section at a first time and said second image taken by said camera section at a second time after said first time.

2. The monitoring system according to claim 1, wherein said monitoring system further comprises a network,
said request unit is provided for a first terminal on a side of said user which is connected with said network,
said state data generating unit is provided for a second terminal connected with said first terminal through said network, to receive said state data request through said network and to transmit said state data to said first terminal.

3. The monitoring system according to claim 1, wherein said monitoring system comprises a network and a server connected with said network,
said request unit is provided for a first terminal on a side of said user which is connected with said network,
said state data generating unit is provided for a second terminal connected with said first terminal through said network, to receive said state data request through said network and to store said state data in said server, and
said first terminal acquires said state data from said server.

4. The monitoring system according to claim 1, wherein said monitoring system comprises a network,
said request unit is provided for a first terminal on a side of said user which is connected with said network,
said state data generating unit is provided for a second terminal connected with said first terminal through said network, to hold said generated state data, and
said first terminal acquires said state data from said second terminal.

5. The monitoring system according to claim 1, wherein said monitoring system comprises a network,
said request unit and said state data generating unit are provided for a first terminal on a side of said user which is connected with said network.

6. The monitoring system according to any of claims 2 to 5, wherein said camera section is connected with said state data generating unit through said network.

7. The monitoring system according to any of claims 2 to 4, wherein said state data generating unit transmits said state data in one of formats of Web site data and E-mail.

8. The monitoring system according to any of claims 1 to 7, wherein said state data generating unit comprises:
a request input section which receives said state data request;
a determining section which supplies said state data showing the presence/absence state of said target person in said predetermined area based on said first image and said second image in response to reception of said state data request by said request input section; and
a result output section which outputs said state data supplied by said determining section.

9. The monitoring system according to claim 8, wherein said determining section determines the presence/absence state of said target person in said predetermined area based on a brightness difference between corresponding pixels of said first image and said second image in response to reception of said state data request by said request input section, and generates said state data showing the result of said determination.

10. The monitoring system according to claim 8 or 9, wherein said result output section has a result storage section which stores said state data,
said result output section compares said state data supplied by said determining section as a current state data and the state data stored in said result storage section as a previous state data, and outputs said current state data when said current state data does not coincide with said previous state data.

11. The monitoring system according to any of claims 8 or 10, wherein said state data generating unit comprises:
a statistical data calculating section which calculates a statistical data showing a statistic value of a result of said determination based on said state data.

12. The monitoring system according to claim 11, wherein said statistic data is an absence state percentage

13. The monitoring system according to claim 11, wherein said statistic data is a degree of congestion.

14. The monitoring system according to any of claims 11 to 13, wherein said state data generating unit generates and said state data showing the presence/absence state of said target person in said predetermined area based on said first image and said second image and stores in the state data storage section together with a date and time data,
said statistic data calculating section calculates said statistic data based on a time series of said state data and a time series of said date and time data stored in said state data storage section.

15. The monitoring system according to claim 14, wherein said statistic data is a time change of the degree of congestion.

16. The monitoring system according to claim 14, wherein said statistic data is a time change of a congestion place.

17. The monitoring system according to claim 14, wherein said statistic data is a time change of a flow of persons.

18. The monitoring system according to any of claims 1 to 17, wherein said state data generating unit always obtains said second image from said camera section and generates said state data and supplies the latest state data in response to said state data request.

19. The monitoring system according to any of claims 1 to 17, wherein said state data generating unit obtains said second image from said camera section in response to said state data request, and generates said state data and supplies said state data.

20. A monitoring method may include:
(a) taking a predetermined area for a target person as an image, wherein a first image is taken at a first time and a second image is taken at a second time after said first time;
(b) issuing a state data request to request a state data showing a state of the target person;
(c) providing said state data showing a presence/absence state of said target person in said predetermined area based on said first image and said second image in response to said state data request; and
(d) showing said state data acquired in response to said state data request won to the user.

21. The monitoring method according to claim 20, wherein said state data is one of formats of a Web site data and E-mail.

22. The monitoring method according to claim 20 or 21, wherein said (c) providing comprises:
(e) receiving said state data request;
(f) supplying said state data showing the presence/absence state of said target person in said predetermined area based on said first image and said second image in response to the reception of said state data request; and
(g) outputting the supplied state data.

23. The monitoring method according to claim 22, wherein said (f) supplying comprises:
determining the presence/absence state of said target person in said predetermined area based on a brightness difference between corresponding pixels of said first image and said second image in response to the reception of said state data request; and
generating and supplying said state data based on a result of said determination.

24. The monitoring method according to claim 22 or 23, wherein said (g) outputting comprises:
comparing said state data supplied as current state data and a previous state data; and
outputting said current state data, when said current state data does not coincide with said previous state data.

25. The monitoring method according to any of claims 22 to 24, further may include:
calculating a statistical data showing a statistics of the results of said determination based on said state data.

26. The monitoring method according to claim 25, wherein said statistic data is an absence state percentage.

27. The monitoring method according to claim 25, wherein said statistic data is a degree of congestion.

28. The monitoring method according to claim 25, wherein said (f) supplying comprises:
generating said state data showing the presence/absence state of said target person in said predetermined area based on said first image and said second image;
holding said state data together with a date and time data, and
said calculating comprises:
calculating said statistic data based on a time series of said state data and a time series of said date and time data stored in a state data storage section. The method of monitoring

29. The monitoring method according to claim 28, wherein said statistic data is a time change of a degree of the congestion.

30. The monitoring method according to claim 28, wherein said statistic data is a time change of a congestion place.

31. The monitoring method according to claim 28, wherein said statistic data is a time change of a flow of persons.

32. The monitoring method according to any of claims 20 to 31, wherein said (a) taking is always carried out,
said (c) providing comprises:
generating said state data from said second image;
supplying the latest state data in response to said the state data request.

33. The monitoring method according to any of claims 20 to 31, wherein said (a) taking is carried out to take said predetermined area for said target person in response to said the state data request;
said (c) providing comprises:
getting said second image in response to said state data request; and
generating and supplying said state data based on said first image and said second image.

34. A recording medium in which a program is stored for executing a monitoring method, may include:
(a) taking a predetermined area for a target person as an image, wherein a first image is taken at a first time and a second image is taken at a second time after said first time; and
(b) providing said state data showing a presence/absence state of said target person in said predetermined area based on said first image and said second image in response to a state data request.

35. The recording medium according to claim 20, wherein said state data is one of formats of a Web site data and E-mail.

36. The recording medium according to claim 34 or 35, wherein said (b) providing comprises:
(c receiving said state data request;
(d) supplying said state data showing the presence/absence state of said target person in said predetermined area based on said first image and said second image in response to the reception of said state data request; and
(e) outputting the supplied state data.

37. The recording medium according to claim 36, wherein said (d) supplying comprises:
determining the presence/absence state of said target person in said predetermined area based on a brightness difference between corresponding pixels of said first image and said second image in response to the reception of said state data request; and
generating and supplying said state data based on a result of said determination.

38. The recording medium according to claim 36 or 37, wherein said method comprises
(f) outputting the supplied state data, and
said (f) outputting comprises:
comparing said state data supplied as current state data and a previous state data; and
outputting said current state data, when said current state data does not coincide with said previous state data.

39. The recording medium according to any of claims 36 to 38, wherein said method further comprises:
calculating a statistical data showing a statistics of the results of said determination based on said state data.

40. The recording medium according to claim 39, wherein said statistic data is an absence state percentage.

41. The recording medium according to claim 39, wherein said statistic data is a degree of congestion.

42. The recording medium according to claim 39, wherein said (d) supplying comprises:
generating said state data showing the presence/absence state of said target person in said predetermined area based on said first image and said second image; and
holding said state data together with a date and time data, and
said calculating comprises:
calculating said statistic data based on a time series of said state data and a time series of said date and time data stored in a state data storage section. The method of monitoring

43. The recording medium according to claim 42, wherein said statistic data is a time change of a degree of the congestion.

44. The recording medium according to claim 42, wherein said statistic data is a time change of a congestion place.

45. The recording medium according to claim 42, wherein said statistic data is a time change of a flow of persons.

46. The recording medium according to any of claims 34 to 45, wherein said (a) taking is always carried out,
said (b) providing comprises:
generating said state data from said second image;
supplying the latest state data in response to said the state data request.

47. The recording medium according to any of claims 34 to 45, wherein said (a) taking is carried out to take said predetermined area for said target person in response to said the state data request;
said (b) providing comprises:
getting said second image in response to said state data request; and
generating and supplying said state data based on said first image and said second image.
